(19) United States
(12) Patent Application Publication
(10) Pub. No.: US 2025/0068133 A1
(43) Pub. Date: Feb. 27, 2025

(54) PROTOCOL AGNOSTIC DATA STRUCTURE FOR TELEMETRY MEASUREMENT OF OPERATIONAL CONDITIONS OF NETWORKED DEVICES

(71) Applicant: Sclera Holdings, LLC, Wheeling, IL (US)

(72) Inventors: Vikram HEGDE, Prospect Heights, IL (US); Rajath Rao KANANGOLA, Prospect Heights, IL (US); Rithesh HALMA, Karnataka (IN)

(21) Appl. No.: 18/453,242

(22) Filed: Aug. 21, 2023

(51) Int. Cl. G05B 15/02

(52) U.S. Cl. CPC G05B 15/02

(57) ABSTRACT

A computer system connected within a local network ingests telemetry data received from devices or sensors located within a premises and connected to the network. A virtual measuring instrument module instantiates within the computer system and includes communication protocol interfaces and predefined data transformation tools provisioned for interaction with telemetry data generated by the devices or sensors. The application associates with a subnetwork of the local network to which the devices or sensors are collectively connected. The subnetwork uses a first communication protocol that is different a protocol used on the local network. The communication protocol interfaces include a first interface that uses the first communication protocol. The telemetry data is received within the application from the devices or sensors on the first subnetwork using the first communication protocol interface as received telemetry data. The predefined data transformation tools translate a format of the received telemetry data to a normalized format. A presentation of the normalized telemetry data is configured for output to a user device.

### TECHNICAL FIELD

The technology presented here is generally directed towards a method to collect and compute operational data from a plurality of devices or related sensors connected to a communication network.

### BACKGROUND

The management of large commercial spaces has become increasingly complex due to the proliferation of various functions and devices that are integrated into modern premises. These include but are not limited to HVAC systems, lighting controllers, audio-visual equipment, security and video surveillance systems, water heaters, gas and electricity systems, network devices, building automation, appliances, Wi-Fi infrastructure, cellular network boosters, access control, fire panels, and telephony systems. With an evolving need for better infrastructure, premises are installed with hundreds, if not thousands, of devices and sensors. Exemplary premises can include, but are not limited to, hotels, hospitals, shopping malls, warehouses, educational institutions, commercial complexes etc. Device systems on premises are disparate and siloed in most facilities, and facility managers find it difficult to manage and ensure all the systems are operating optimally and efficiently. A comprehensible understanding of the performance of all the devices and sensors by facility managers is desirable to detect failures, avoid costly downtime, make informed decisions, manage manual labor, and use capital effectively.

Without collection and recordation of operational data from all devices within a premises, it is difficult for facility managers to monitor the real-time performance of the assets. This shortcoming results in delayed responses to asset failures, unknown needs for maintenance and repair, and unfavorable downtime. Additionally, facility managers are unable to observe trends and patterns that could potentially predict the future maintenance and proactive measures for certain assets. A lack of data measurement and analysis also results in non-optimized energy usage and failure to identify areas of energy waste, which can pose a risk to an organization's sustainability and regulatory compliance. Asset performance data can also be helpful for facility manager to make informed decisions about capital expenditures, repair and maintenance, human resources efficiency, and uptime vs. downtime.

Existing measuring systems and methods have various drawbacks, primarily because they are based upon a tedious, manual, non-digitized data collection approach. Manual recordation of asset data poses a high risk of errors that can occur through misinterpretation, misreading, and mistyping of data. The process is time-consuming, especially in the context of multi-complex premises and organizations with large numbers of and different types of devices and sensors. Manual data collection often uses physical paper or computer spreadsheets, which limit the accessibility, transparency, and accountability in any data collected. Further, as data readings and outputs are prone to constant fluctuations, it is difficult to track such changes when they are captured manually, leading to inconsistencies and unreliability.

In light of these limitations mentioned, some existing methodologies have attempted digitized approaches to collecting, computing, and measuring telemetry data from sensors within systems. However, the telemetry data is typically collected through a single protocol that does not represent the full range of behaviors or characteristics in the broader scheme of networks or systems. Protocols are essentially a set of rules or guidelines that define how data should be transmitted, received, and interpreted between devices. For example, if a specific type of data value can be collected using the building automation and control network (BACnet) communication protocol, existing methodologies are limited to computed data available through devices/sensors that comply only with the BACnet protocol. If other devices are configured to use another communication protocol, for example, low power wide area networking (LoRaWAN), a different system is needed to measure and record data values from devices/sensors supported by the different protocol. Existing methodologies generally do not enable collection of telemetry data collected from more than one protocol, much less incorporating and processing telemetry data from different protocols within a single platform to provide integrated information about multiple operations of the premises assets.

The information included in this Background section of the specification, including any references cited herein and any description or discussion thereof, is included for technical reference purposes only and is not to be regarded subject matter by which the scope of the invention as defined in the claims is to be bound.

### SUMMARY

The present disclosure us directed to a scalable system to perform combined and complex functions on metrics derived from multiple protocols supporting a plurality of devices and related sensors to deliver insightful readings—resulting in increased efficiency of assets, optimal use of manual labor, informed decision-making by managers, and logical cost expenditures. Implementations of the system include an access control device configured through software with a measuring instrument template and a corresponding method that collects telemetry data from devices and sensors on a networks that are configured using diverse data protocols. The system performs calculations and functions on the collected telemetry data to arrive at desired outputs in a unified data format and measurements that facilitate and enable management of complex premises. The measuring instrument is implemented through software on an access control device and is compatible with multiple protocols associated with a plurality of devices and sensors. An example implementation of an access control device and related methods of operation are disclosed in U.S. Pat. No. 11,522,782 B2 and U.S. patent application Ser. No. 18/338,163 filed 20 Jun. 2023 entitled “Port-to-port tunnel creation for secure remote access to networked devices,” which are hereby incorporated by reference herein in their entireties. The access control device as configured herein computes telemetry data from all the connected devices in an internet of things (IoT) environment, regardless of the device type, brand, and communication protocol.

The access control device is connected to a local area network (LAN) behind a gateway or network access device (e.g., a router or other network address translator (NAT) device). The access control device also may be communicably coupled with a plurality of devices connected on the LAN, either directly or via one or more switches. It may also be coupled with systems over a wide area network, e.g., from two or more LANs or the internet, to capture telemetry data from a wider network of devices and provide broader, integrated coverage across different premises. The access control device communicates with the devices from different protocols over LAN and WAN using an application protocol interface (API) and directs collected telemetry data back to the measuring instrument for processing with different computations, formulas, calculations, readings, interpretations, etc. The API sends requests for information from the devices on the network according to the various protocols and ingests the returning information through data transforms to integrate the data on a common platform. With values aggregated from a plurality of devices, the disclosed technology creates a comprehensible interface and displays normalized data output and analytics for consideration by the premises manager or other user, e.g., through a dashboard interface. In addition to the measuring instrument presentation output, the access control device enables the premises management personnel to adjust their preferred settings for alerts or user assignments.

In one example implementation, the techniques described herein relate to a method within a computer system connected within a local network for aggregating diverse telemetry data received from one or more devices or sensors located within a premises and connected to the local network, the method including instantiating a virtual measuring instrument within the computer system, the virtual measuring instrument including one or more communication protocol interfaces and one or more predefined data acquisition tools provisioned for interaction with telemetry data generated by the one or more devices or sensors; associating the virtual measuring instrument with a first subnetwork of the local network to which the one or more devices or sensors are collectively connected, wherein the first subnetwork operates using a first communication protocol that is different from a second communication protocol used on the local network; and the one or more communication protocol interfaces of the virtual measuring instrument include a first communication protocol interface that decodes data according to the first communication protocol; receiving the telemetry data within the virtual measuring instrument from the one or more devices or sensors on the first subnetwork using the first communication protocol interface as received telemetry data; translating, using the one or more predefined data acquisition tools within the virtual measuring instrument, a format of the received telemetry data conforming to the first communication protocol to a normalized format resulting in normalized telemetry data; and configuring a presentation of the normalized telemetry data for output to a user device connected to the local network.

In another example implementation, the techniques described herein relate to a system for aggregating diverse telemetry data within a premises communication network, the system includes the premises communication network including one or more subnetworks; one or more devices or sensors connected to one of the one or more subnetworks; a computing device including one or more hardware processors; and a memory storage device configured with instructions for directing the one or more hardware computing processors to execute application programs and related programing units including a virtual measuring instrument application, when executed by the hardware processors, causes the hardware processors to instantiate a virtual measuring instrument within the computing device, the virtual measuring instrument including one or more communication protocol interfaces and one or more predefined data acquisition tools provisioned for interaction with telemetry data generated by the one or more devices or sensors; associate the virtual measuring instrument with a first subnetwork of the premises communication network to which the one or more devices or sensors are collectively connected, wherein the first subnetwork operates using a first communication protocol that is different from a second communication protocol used on the premises communication network; and the one or more communication protocol interfaces include a first communication protocol interface that decodes data according to the first communication protocol; receive the telemetry data within the virtual measuring instrument from the one or more devices or sensors on the first subnetwork using the first communication protocol interface as received telemetry data; translate, using the one or more predefined data acquisition tools, a format of the received telemetry data conforming to the first communication protocol to a normalized format resulting in normalized telemetry data; and configure a presentation of the normalized telemetry data for output to a user device connected to the local network.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments and implementations and illustrated in the accompanying drawings.

### BRIEF DESCRIPTION OF DRAWINGS

The disclosure will be readily understood by the following detailed description in conjunction with the accompanying drawings, wherein like reference numerals designated like structural elements. The use of cross-hatching or shading in the accompanying figures is generally provided to clarify the boundaries between adjacent elements, e.g., when shown in cross-section, and also to facilitate the legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented there between, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto. In some examples, one element may be designed as multiple elements, or multiple elements may be designed as one element. In some examples, an element shown as an internal component of one element may be implemented as an external component in another and vice versa. Furthermore, the elements may not be drawn to scale.

FIG. 1 is a schematic diagram of an exemplary implementation of a communication network connecting a plurality of properties managed by a single proprietor through an access control device for the collection, aggregation, and analysis of operational data from myriad subnetworks in each premises.

FIG. 2 is a schematic diagram of exemplary implementations of multiple subnetworks obeying varying protocols on a premises network connected to a single access control device for all data collection.

FIG. 3 is a schematic diagram of an exemplary implementation of a network installation employing measuring instrument templates equipped in a central access control device to aggregate and analyze telemetry data from a plurality of devices regardless of the underlying protocols.

FIG. 4 is a flow diagram presenting the application of a measuring instrument template on telemetry data received from a plurality of devices within the premises.

FIG. 5 is a schematic diagram of an exemplary implementation of premises devices following different protocols as processed by application of specific measuring instrument templates.

FIG. 6 is a flow diagram representing the telemetry data acquisition and aggregation from various protocols, decoding, template application, and normalization of the data output.

FIG. 7 is a schematic diagram of exemplary components of computer devices used to implement the virtual measuring instrument system as disclosed herein.

### DETAILED DESCRIPTION

Various embodiments of a disclosed system and method for implementing A virtual measuring instrument application are discussed herein with reference to the accompanying figures. However, it should be appreciated that the disclosed virtual measuring instrument may be implemented in other manners or with additional or fewer features or components than the described example embodiments depending upon the needs of a particular application. Therefore, additional approaches to implement the disclosed virtual measuring instrument application than the implementation choices in the following embodiments are contemplated.

Various types of premises infrastructure systems with large numbers of different types devices, for example, HVAV units, security and camera systems, fire detection and suppression systems lighting controls, WiFi® routers, thermostats, door lock systems, etc., to provide needed functionality to the premises. Many of these devices include sensors that monitor and record conditions and status of the devices or the ambient environment in which the devices operate. Many of these devices and sensors in commercial application situations are equipped with communication transceivers for remote transmission of collected data, interrogation, and receipt of instructions or new software, e.g., firmware. Depending upon the type of device and the manufacturer, one of many different communication protocols may be used for transmission and reception of such telemetry data and instructions, for example, BACnet, LoRaWAN, Simple Network Management Protocol (SNMP), Konnectivity Network X (KNX), Digital Addressable Lighting Interface (DALI), ZigBee (IEEE 802.15.4), MODBUS, etc. Each of these protocols also presents data in different formats and uses different physical interfaces.

The disclosed virtual measuring instrument application can be understood as a middleware application that harnesses the functionality of an access control device on the LAN to receive, interpret, normalize, and uniformly format data input from these different platforms and derive actionable insights therefrom. The virtual measuring instrument application also enables numerous approaches for sourcing the telemetry data—multiple data from the same protocol or platform, multiple data from different protocols or platforms, data from digitized manual values, a combination of multiple data from a single protocol and digitized manual values, a combination of multiple data from different protocol and digitized manual values, and other permutations and combinations of data sources. The data output can be customized to provide relevant and actionable information for the type of device, sensor, industry, or premises.

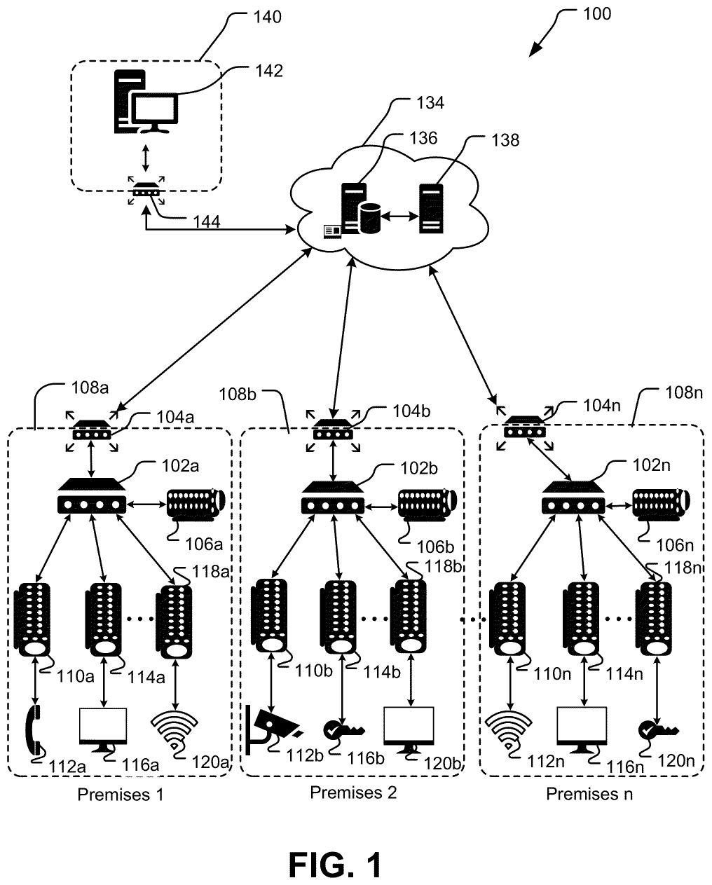

An example network installation 100 is depicted in FIG. 1 and exemplifies a configuration where a plurality of devices are installed across a several premises located at geographically separate locations, such as hotels, residential apartment buildings, student housing, assisted living facilities, commercial buildings, hospitals, and warehouses, that are connected through unique local area networks (LANs), and collectively referred to as the premises networks 18a/b/n. Access control devices 102a/b/n for each property are included in the disclosed network installation 100 and are communicatively coupled with the various devices connected to the premises networks 108a/b/n to collect and compute operational data, as well as assess and measure device performance.

In a practical application, the access control devices 102a/b/n may be centrally managed and installed in respective premises which are equipped with a diverse range of connected devices, which can include, but are not limited to, wireless access points (WAPs), network gateways and switches, computer servers, client computers, point-of-sale (PoS) systems, interface devices, telephone systems, internet protocol televisions (IPTV) management systems, energy management systems, automation systems, heating/ventilation/air conditioning (HVAC) systems, water boilers, and security systems. The access control devices 102a/b/n can be connected to all of these different systems. Each premises network 108a/b/n can also be connected to a remote server platform 134 to allow for central data storage for and control of multiple access control devices 102a/b/n to provide for central management of a plurality of commonly owned or managed premises. The remote server platform 134 can include one or more data storage servers 136 and one or more proxy servers 138 for user and network authentication to ensure security and limited and controlled access to each of the premises networks 108a/b/n through the access control devices 102a/b/n.

The access control devices 102a/b/n are each a specialized computer device including one or more processors, memory capable of hosting software applications, data storage, and communication connections (e.g., Ethernet ports, universal serial bus (USB) ports, etc.,) to connect the access control devices 102a/b/n to the respective premises networks 108a/b/c. The access control devices 102a/b/n can also be securely connected to a client computer system 142 on a remote network 140 via a network access device 144 on the remoted network 140. The client computer device 142, such as a tablet, smartphone, desktop computer, laptop computer, or other similar device, can be equipped with user interface software controlling a communication interface through which the client computer device 142 can communicate with one or more of the access control devices 102a/b/n on respective premises networks 108a/b/n. The access control devices 102a/b/n are thus able to be accessed by the premises operator, a facility manager, or any designated end user. The access control devices 102a/b/n are further configured to present operational data obtained from the connected devices on the premises networks 108a/b/n. In some cases, a user interface may also be integrated within the access control device 102a/b/c for direct control of functionality of the access control devices 102a/b/n.

The access control devices 102a/b/n may be communicatively coupled with respective core switches 106a/b/n (e.g., an Ethernet switch) and one or more subnetwork switches 110a/b/n, 114a/b/n, 118a/b/n (e.g., Ethernet switches) for subnetworks of like devices managed on each property. Additionally, each of the subnetwork switches 110a/b/n, 114a/b/n, 118a/b/n can be connected with the core switches 106a/b/n. For example, the first subnetwork switch 110a on Premises 1 may be connected to a plurality of telephone devices on a premises telephone network 112a (e.g., a private branch exchange (PBX)). A second subnetwork switch 114a on Premises 1 may be connected to a plurality of televisions on a premises hospitality video distribution network 116a. A third subnetwork switch 118a on Premises 1 may be connected to a plurality of wireless router devices on a premises Wi-Fi network 120a (e.g., an extended network or a mesh network). Many more additional device subnetworks can be managed on the premises network 108a and connected to the access control device 102a. These are merely examples. The example subnetworks 110a, 114a, 118a connected to their respective set of devices are connected to access control device 102a on Premises 1 and all the operational telemetry data is collected and compiled by that access control device 102a, which can be configured to compute operational performance analysis and measurements from data received pursuant to various protocols used by the disparate devices on the subnetworks as further described herein.

In Premises 2, the first example subnetwork switch 110b may be connected to a plurality of security camera devices (e.g., video cameras, digital video recorders (DVR) and network video recorders (NVR)) on a closed-circuit security camera network 112b. A second example subnetwork switch 114a on Premises 2 may be connected to a plurality of key-less door lock devices (e.g., magnetic card or smart phone activated door locks on a hotel property) on a door security network 116b. The third example subnetwork switch 118b of Premises 2 may be again connected to the plurality of television on a premises hospitality video distribution network 120b. Many more additional device subnetworks can be managed on the premises network 108b and connected to the access control device 102b. These are merely examples. Similarly, an access control device 102b can connect to the core switch 106b and the plurality of subnetwork switches 112b, 116b, 120b of multiple like devices to collect and compile device data within the access control device 102b for computation of the collected telemetry data.

In Premises n, a first example subnetwork switch 110n may be connected to a plurality of wireless router devices on a premises Wi-Fi network 112 (e.g., an extended network or a mesh network). A second example subnetwork switch 114n of Premises n may be again connected to the plurality of television on a premises hospitality video distribution network 116n. A third example subnetwork switch 118n on Premises n may be connected to a plurality of key-less door lock devices (e.g., magnetic card or smart phone activated door locks on a hotel property) on a door security network 120n. Many more additional device subnetworks can be managed on the premises network 108n and connected to the access control device 102n. These are merely examples. Similarly, the access control device 102n can connect to the core switch 106n and the plurality of subnetwork switches 112n, 116n, 120n of multiple like devices to collect and compile device data within the access control device 102n for computation of the collected telemetry data.

The subnetworks illustrated in FIG. 1 and explained here are just examples of potential premises systems. Other premises systems such as building automation, appliances, audio-visual systems, lighting controllers, cellular network boosters, fire panels/alarms, and security systems can also be connected to the access control devices 102a/b/n and the Ethernet core switches 106a/b/c via subnetwork switches 110a/b/n, 114a/b/n, 118a/b/n. Connections between the access control devices 102a/b/n, their respective Ethernet core switches 106a/b/n, and subnetwork switches 110a/b/n, 114a/b/n, 118a/b/n can be established via various physical or wireless connections such as Ethernet, Wireless Local Area Network (WLAN), Bluetooth, Zigbee, Long Term Evolution (LTE), Worldwide Interoperability for Microwave Access (WiMAX), and General Packet Radio Service (GPRS).

The Ethernet core switches 106a/b/n in FIG. 1 can provide a compact, programmable, and scalable aggregation of premises device networks 112a/b/n, 116a/b/n, 120a/b/n that interconnect through a plurality of subnetworks 110a/b/n, 114a/b/n, 118a/b/n, and can further interconnect across different premises, thereby creating an enterprise-level network system. The number of subnetworks that can be connected to the core switches is not limited to the examples shown and can be increased as required. Each of the subnetwork switches 110a/b/n, 114a/b/n, 118a/b/n can connect multiple devices from device networks 112a/b/n, 116a/b/n, 120a/b/n over physical or wireless networks. The core switches 106a/b/n can receive communication data from each of the subnetwork switches 110a/b/n, 114a/b/n, 118a/b/n to manage multiple data transmissions between devices on the subnetwork switches 110a/b/n, 114a/b/n, 118a/b/n simultaneously. Local device monitoring and control can be performed through separate control system software via one or more client computer devices on the premises networks 108a/b/n or via an integrated management platform executed on the access control devices 102a/b/n.

An integrated management platform on or across the access control devices 102a/b/n may use a library of protocols and application programming interfaces (APIs) to communicate with all the devices on the device subnetworks 112a/b/n, 116a/b/n, 120a/b/n to collect and compute the telemetry data captured in the plurality of devices or sensors. For example, in Premises 1, the plurality of wireless router devices on a premises WiFi network 120a can be connected to the subnetwork switch 118a via similar or varying protocols. Similarly, all the subnetwork switches 110a, 114a, 118a connected to respective device networks 112a, 116a, 120a may obey similar protocol or varying protocols. The data, irrespective of the protocol utilized for encoding or transmission, is communicated to the access control device 102a for further data processing and computing.

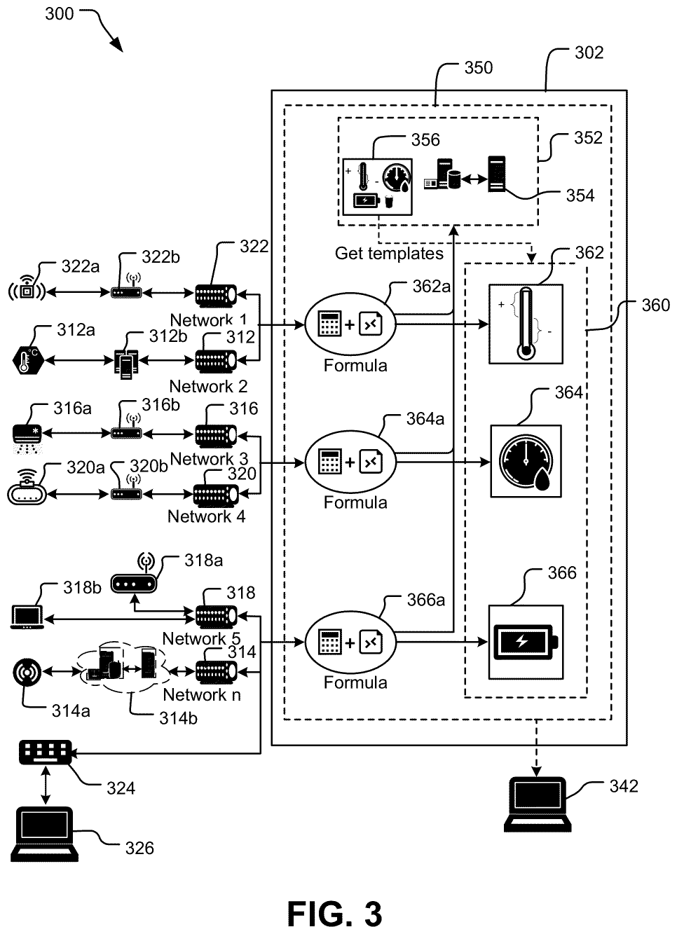

The data captured from the wide range of sensors and devices passes through the respective access control devices 102a/b/n before being transmitted to any external network, e.g., the internet 122. Each access control device 102a/b/n is equipped with virtual “measuring instruments” or templates (as further described herein) that normalize the telemetry data and perform necessary mathematical/computational functions on the normalized data to provide a desired output. The details of the measuring instruments within the access control device are disclosed in FIG. 3. The data computation is processed according to the template or measuring instrument chosen or configured by the premises manager or any designated end user to analyze the status of some or all the devices and sensors installed in the respective premises. Values derived from a plurality of devices via different protocols can be subject to a wide range of functions to provide a comprehensible report or information with in-depth analysis of facility management including, but not limited to, operational trends, up-time vs. down-time, load or usage over time, repair status of assets, conditional alerts, maintenance updates, and a combinational output of any number of data points from any number of protocols.

The comprehensible data traffic computed in the access control devices 102a/b/n can be passed to the network access devices 104a/b/n (for example, a cable or digital subscriber line modem or router), respectively, for transfer to external users accessing the premises networks 108a/b/n with proper authorization and through secure communication channels, or for external storage and long-term aggregation and access. FIG. 1. depicts an example external network 140 and a remote server platform 124 in communication with the access control devices 102a/b/n of all the premises to provide a secure communication between an authorized remote user (e.g., facility/premises manager), the details of which are disclosed in U.S. patent application Ser. No. 18/338,163 filed 20 Jun. 2023 entitled “Port-to-port tunnel creation for secure remote access to networked devices.” The regulated and normalized data can be transmitted to and presented upon a user interface of a remote computing device 140 located at a location outside of the premises of all properties or within the premises of one of those properties. As depicted, the remote end user system 142 can be set up behind a network access device 144 on a separate, remote local network 140. The end user is therefore able to access both real-time data collected across multiple protocols or networks in a comprehensible fashion after processing by the templates.

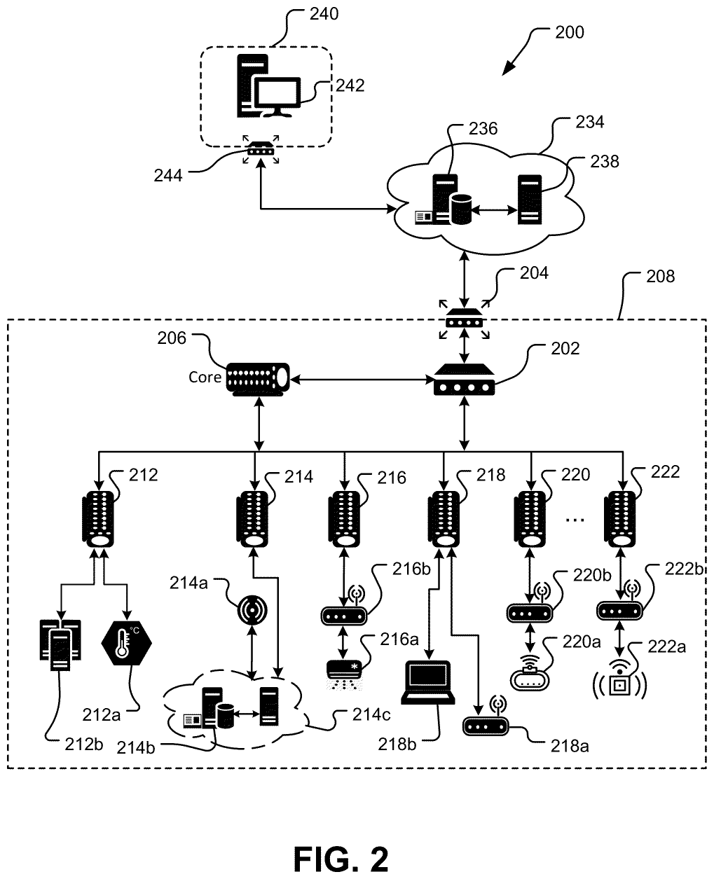

FIG. 2 illustrates a schematic diagram of an exemplary system architecture 200 for the disclosed. The system architecture 200 includes an access control device 218 that is connected to a plurality of devices or sensors on a premises network 208 through multiple subnetwork switches 202, 204, 26, 208, 210, 212, each following a unique protocol. In this example installation various data transmission protocols, such as Modbus, Zigbee, BACnet, LoRaWAN, SNMP, etc., are presumed to be used to collect data from different types of devices/sensors installed in the premises. The diverse range of network protocols in this environment creates complexity for aggregating and analyzing data inputs that are presented in varying formats and templates.

Different protocols are adapted in premises management systems for a variety of reasons including, for example, the industry standard for the device/sensor type, the manufacturer selection, the type of data being transmitted, the distance over which it needs to be transmitted, the level of security required, and the reliability and speed of the network. For example, protocols such as Bluetooth and Zigbee are often used for short-range communications, while Ethernet and Wi-Fi are commonly used for longer-range transmissions. Additionally, protocols such as HTTPS and SSL are used to ensure secure transmission of sensitive data, while other protocols may prioritize speed and reliability, such as in the case of real-time monitoring and control applications. Ultimately, the choice of protocol depends on the specific needs and requirements of the devices or sensors. A fully integrated premises management system is thus deficient without collection and computation of data from different protocols. An integrated system can perform measurements through a unified template, creating normalized data and providing comprehensible outputs for actionable insights by the end user.

The premises network 208 can also be connected to a remote server platform 234 to allow for central data storage for and control of multiple access control devices 202 to provide for central access to and management of a plurality of commonly owned or managed premises. The remote server platform 234 can include one or more data storage servers 236 as well as one or more proxy servers 238 for user and network authentication to ensure security and limited and controlled access to the premises network 208 through the access control devices 202. The remote server 222 on the remote server platform 220 can be connected to multiple LANs, for example to the premises network 208 through network access device 216 and to a remote user LAN 240 through a network access device 244. The network access devices 204, 244 inspect the source and destination addresses of data traffic and forward the traffic to the appropriate network segment, subnetwork, or network device (e.g., to a port address on the device) based on the routing information stored in an internal routing table. Network access devices 204, 244 help to improve network performance and security by reducing the amount of broadcast traffic and limiting the scope of network traffic within the organization's internal premises network 208 or other LAN.

The remote user may be located at a remote location with a client computer system 242 that is configured with a user interface for communication with the access control device 202 on the premises network 208, the remote server platform 234, and other components of the premises management system. Coordinated software on the client computer system can display processed data output or compilations or aggregations of data from a plurality of devices in the premises network 208 in a comprehensible fashion to the designated end user. The access control device 202 is positioned between the network access device 204 and core switch 206, as well as the dedicated subnetwork switches 202, 204, 206, 208, 210, 212, to provides secure access from remote users to devices connected to the subnetwork switches 202, 204, 206, 208, 210, 212 and to collect and process device and sensor data collected on the premises network 208. As shown in the implementation of FIG. 2, the subnetwork switches 202, 204, 206, 208, 210, 212 of like devices managed on the premises network 208 can be attached directly to both the access control device 202 and the core switch 206. The access control device 202 can manage secure access to the device networks from external or remote users, e.g., client computer system 242 or the remote server platform 234, while the core switch can be configured to handle routine communication traffic internal to the premises network 208.

As noted, each device or sensor subnetwork may operate on a different communication protocol. For example, the first subnetwork switch 212 may be connected to a plurality of temperature sensors 212a reporting to a local server 212b. The temperature sensors 212a can be connected to the subnetwork switch 212 and the local server 212b can also be connected to the subnetwork switch 212. The subnetwork switch 212 acts as a bridge between the temperature sensors 212a and the local server 212b, allowing the data to be transmitted between the two devices. The local server 212b typically has software installed that communicates with temperature sensors 212a through an application protocol interface (API). The API allows the software to receive the telemetry data sent by the temperature sensors 212a and process it as necessary. For example, the software might be programmed to analyze the temperature data to identify trends or to send alerts if certain temperature thresholds are exceeded. In this example implementation, the premises management system of the premises network 208 leverages a local server 212b to communicate with and normalize and process the telemetry data received from a plurality of temperature sensors 212a connected to the subnetwork switch 212. This process data can be forwarded from the subnetwork switch 212 through the access control device 202 to a remote client device 242 for secure presentation to a remote user or to the remote server platform 234 for longer term data storage on a database server 236.

The second subnetwork switch 214 may be connected to a plurality of third-party applications 214a reporting to a third-party server 212b over a wide area network (WAN) 214c implemented physically within the premises, but separate from the premises network 208. The third-party application 214a sends telemetry data to the third-party server 214b over the WAN 214c using a specific protocol such as HTTP or HTTPS. The third-party server 214b receives the telemetry data and translates it into a format that can be understood by the subnetwork switch 214, e.g., Ethernet protocol, using APIs or other software tools. Once the telemetry data is received by the subnetwork switch 214, it may also be transmitted to the access control device 202 for data computation using various templates and calculations, the details of which are further explained if FIG. 3.

The third subnetwork switch 216 may be connected to a plurality of BACnet devices 216a obeying BACnet protocols to collect telemetry data through a BACnet gateway 216b. The BACnet devices 216b transmit this telemetry data via the BACnet protocol to the BACnet gateway 216b, which serves as an intermediary between the devices and the subnetwork switch 216. The BACnet gateway 216b may then convert the BACnet data into a suitable format for transmission, such as Ethernet or IP, and sends the converted data packets to the subnetwork switch 216. The subnetwork switch 216 receives the data packets and forwards them to the appropriate destinations within the premises network 208, facilitating effective communication and enabling data transmission and control actions between the BACnet devices 216a and the premises network 208. For example, consider BACnet-enabled lighting controllers in different areas of the premises. The BACnet protocol collects telemetry data from the sensors embedded within the lighting system, such as occupancy sensors or light level sensors, to provide valuable information for controlling the lighting conditions. The collected sensor data, along with the status of the controller and performance metrics, are transmitted through the BACnet protocol to the BACnet gateway. The BACnet-enabled lighting controller ensures efficient and synchronized control of the lighting system, enhancing energy efficiency, occupant comfort, and overall facility management.

In the exemplary embodiment of network installation 200, a fourth subnetwork switch 218 may be coupled with Simple Network Management Protocol (SNMP) devices 218a. The SNMP devices 218a use the SNMP protocol to communicate with a SNMP manager 218b that collects data and manages network devices, for example, routers, switches, firewalls, load balancers, uninterruptable power supplies, servers, network printers, and other network equipment. The SNMP manager 218b is typically a software application instantiated on a user device connected to the subnetwork switch 218 used to monitor and manage network-connected SNMP devices 218a. The SNMP manager 218b can retrieve information, such as device status, performance metrics, and configuration settings, configure settings, and receive alerts or notifications from the SNMP devices 218a also connected to the subnetwork switch 218. This information is typically organized in a hierarchical structure called the management information base (MIB). The subnetwork switch 218 acts as a connection point within the premises network 208, allowing the SNMP devices 218a to interact with the access control device 202.

The fifth subnetwork switch 220 maybe coupled with a plurality of KNX devices 220a via a KNX gateway 220b used to bridge the communication between the subnetwork switch 220 and the plurality of KNX devices 220b, all operating on the KNX protocol for data transmission. In the exemplary network installation 200 representing a commercial space, KNX is a protocol for controlling and managing various building automation devices, including lighting, HVAC, blinds, and security systems. The KNX gateway 220b acts as an interface or translator, allowing the subnetwork switch 220 to communicate with the KNX devices 220a using the KNX protocol. For example, for multiple KNX lighting controllers installed on different floors of a commercial building, each KNX gateway 220b can handle managing the lighting for a respective floor or area. By utilizing the KNX gateway 220b and the subnetwork switch 220, the premises management system can centrally control and manage the lighting system in the building. The subnetwork switch 220 facilitates the transmission of control commands between the KNX gateway 220b and the KNX lighting controllers, ensuring efficient and synchronized lighting control across different areas of the facility. The integration of these components enables effective control, monitoring, and management of the lighting system for optimal energy efficiency and occupant comfort.

Similarly, the representation of subnetwork switch 222 in this embodiment may be connected to plurality of sensors 222a using the LoRaWAN communication protocol through a LoRaWAN gateway 222b. For example, the sensors 222a could be sensors for measuring occupancy parameters, which include, but are not limited to, detecting the presence or absence of people in a room or area, lighting control, optimizing energy usage, and enhancing security by triggering alarms or notifications. LoRaWAN protocols and sensors are selected for their long-range communication capabilities, low power consumption, cost-effective deployment, scalability, wide range of applications, and interoperability. LoRaWAN enables data transmission over long distances, extends battery life for devices, requires minimal infrastructure modifications, accommodates a large number of devices, and supports diverse applications such as environmental monitoring, occupancy detection, energy management, security systems, and asset tracking.

FIG. 2. is an exemplary embodiment representing a network installation 200 that constitutes a plurality of devices obeying a wide-range of protocols that are tailored to unique features and requirements for compatibility, specialized functionality, legacy systems, industry standards, data optimization, and cost consideration. The connection of subnetworks 202, 204, 206, 208, 210 and 212, all coupled with unique protocols, to the centrally installed access control device 208 enables the integration and amalgamation of data retrieved from the plurality of devices obeying the same protocols. This connection and integration also allows for calculations using data values retrieved from a plurality of devices following different communication protocols and different data formats. The access control device 202 collects the data issuing from different protocols and converts it into a unified format and also adapts data normalization and mapping techniques to ensure consistency and compatibility across the outputs. The outputs derived may lead to insightful measurements and performance analysis and actionable decision-making from the end user (e.g., facility manager, premises manager, vendor, client, etc.).

FIG. 3 depicts an exemplary relational schematic 300 within a network installation employing a virtual data management system (VDMS) 350 instantiated within the access control device 302 and incorporating a virtual measuring instrument system 352, which transforms and integrates telemetry data received from a plurality of devices and sensors operating on a wide range of protocols to generate output in a unified format through data normalization and mapping techniques. The VDMS 350 provides for centralized management and control of the devices and sensors on the premises network, enabling facility managers to efficiently monitor energy usage, security systems, environmental conditions, and other critical parameters. Through the VDMS 350, property owners and managers can optimize operations, improve energy efficiency, enhance occupant comfort, and streamline maintenance and facility management processes. Additional details of example implementations of a VDMS 350 on a premises network can be found in U.S. Pat. No. 11,522,782 B2.

The virtual measuring instrument system 352 includes a library 356 of measuring instrument templates and a database 354 to store all the outputs before providing a comprehensible performance analysis of all devices and sensors, and combinations thereof, to the end user, e.g., through remote user device 342. The virtual measuring instrument templates in the library 356 emulate the functionalities and characteristics of a physical measuring instrument without directly interfacing with the physical device. Each measuring instrument template can include parameters and configuration settings that emulate the physical instrument, for example, measurement units, scaling factors, sampling rates, or communication protocols to be used. Each measuring instrument template can also employ a data acquisition system with software tools to acquire data from various sources such as sensors, devices, or databases. These tools can include APIs, communication protocols, or direct database queries to retrieve data.

Once the telemetry data is acquired, the measuring instrument templates apply specific algorithms tailored to the type of device or data to process and analyze the data. Such algorithms can include calculations for statistical analysis, data normalization, filtering, or mathematical operations to derive meaningful insights or measurements. The measuring instrument templates also provide capabilities to present the processed data in a user-friendly format, such as charts, graphs, or dashboards. The measuring instrument templates may also generate reports or alerts based on predefined criteria or thresholds, replicating a visualization and reporting system. The measuring instrument templates may include integration capabilities to communicate with other systems or devices, for example, data exchange, synchronization, or triggering of actions based on the processed measurements. By emulating readings from physical instruments, virtual templates enable the consolidation of data from various sources and protocols into a unified format, providing flexibility, scalability, and customization options within the system.

The database 354 associated with the library 356 of measuring instrument templates serves as a repository for storing and organizing the information related to these templates. The database 354 typically contains structured data that defines the characteristics, properties, and functionalities of the measuring instrument templates. The database 354 allows for efficient storage, retrieval, and management of the template data, making it readily available for access by various applications and processes within the system, including for tasks such as template configuration, data mapping, data computation, data visualization, and analysis. The database 354 ensures that the measuring instrument templates can be effectively utilized and integrated within the broader VDMS 350, enabling seamless data processing and analysis for monitoring, control, and decision-making purposes.

Several examples of implemented measuring instrument templates 360 are presented in FIG. 3 for normalizing data from a plurality of devices following various communications and formatting protocols. Three example measuring instrument templates 362, 364, 366 are selected from the inventory 356 as implemented templates 360 in the network installation 300. The end user of the client system 342 can select an existing measuring instrument template from the inventory 356 or can also add a new measuring instrument templates to the inventory 356. The premises manager or other end user selects desired measuring instrument templates from the inventory 356 for implemented templates 360 based on desired measurement parameters such as temperature, pressure, humidity, flow rate, voltage, current, etc. Selection of implemented templates 360 can also consider parameters such as measurement, range, accuracy and precision, sensor compatibility, data format and units, and other measuring instrument capabilities.

As depicted in the exemplary network installation 300 of FIG. 3, data inputs are derived from devices 302b and 304b, 306b and 308b, 310b and 312b obeying different protocols with varying data formats. The variability in protocols introduces differences in data structures, message formats, and encoding schemes, making direct interpretation and processing difficult. Inconsistencies in units, scales, precision, and data types further complicate the integration and analysis of data. Semantic differences in how parameters are defined and interpreted across protocols can lead to misunderstandings. The complexity of integrating diverse data sources increases with the number of sensors and devices involved. However, data validation, synchronization, and ensuring data quality and validity are important. Standardization efforts, such as common data exchange formats and interoperability frameworks, help address these challenges by facilitating data harmonization and normalization, enabling effective measurement and analysis in heterogeneous environments.

Example measuring instrument templates 362, 364, 366 as shown in the implementation of FIG. 3 facilitate the generation of output in a unified format despite inputs coming from devices 302b and 304b, 306b and 308b, 310b and 312b operating, respectively, on multiple protocols in different formats through a process of data normalization and transformation. The templates 362, 364, 366 are designed to understand the specific characteristics and data structures of different protocols, enabling them to extract relevant data elements and convert them into a standardized format. The templates 362, 364, 366 apply mappings and conversion rules to ensure consistency in units, scales, and data types across the various input sources. The templates 362, 364, 366 also handle the semantic differences by providing a common interpretation and representation of the measured parameters. By leveraging these templates, the VDMS 350 can harmonize the diverse input data, perform necessary calculations or aggregations, and generate output in a unified format that is consistent and compatible with downstream applications or analysis tools. This unified format allows for easier integration, comparison, and analysis of data from different protocols, enhancing the overall efficiency and effectiveness of the measurement process.

For example, a first subnetwork switch 322 is connected to LoRaWan sensors 322a through LoraWAN gateway 322b, communicating with the switch through LoRaWan protocol. In another device network, a second subnetwork switch 312 is connected to local sensors 312a connected to local server 312b communicating with the subnetwork switch 312 through APIs. The subnetwork switches 322, 312 are both assigned the same measuring instrument template 362 from the implemented templates 360, the measuring instrument template 362 is chosen to interface with communication protocols (e.g., LoraWAN) or APIs of the sensors 322a, 312a on the subnetworks 322, 312, type of data desired (e.g., temperature readings) to extract from the subnetworks 322, 312, and/or customizable output desired by the end user. For example, in a smart building, LoRaWAN sensors 322a may be deployed to measure environmental parameters such as temperature, humidity, and air quality, while local devices 312a connected to the local server 312b via APIs can provide telemetry data on energy consumption, occupancy, or security systems. By measuring and analyzing data from both sources, facility managers can gain a holistic view of building operations and make informed decisions regarding energy efficiency, comfort optimization, and security management.

In this example, the measuring instrument template 362 acquires telemetry data using the two unique data transmission methods, the LoRaWan protocol and the API, from the gateway 322b and the local server 312b and performs a set of calculations 362a to compute, process, and analyze the data. Owing to the different protocols followed by the two subnetworks 312, 322 of devices/sensors 312a, 322a, the data format is likely different. The chosen measuring template 362 then consolidates the data into a unified and standardized format, before transmitting the processed data in the specified visualization technique, including but not limited to charts, graphs, or customized dashboards for the end user to analyze and make informed decisions from.

Another measuring instrument template 364 with specific calculation and computation algorithms 364a is applied between a plurality of BACnet devices 316a connected via BACnet gateway 316b to subnetwork switch 316 and a plurality of KNX devices 320b connected via KNX gateway 320a to a subnetwork switch 320. For example, in a commercial building, BACnet devices 316a may include HVAC systems, lighting controls, and access control systems, while KNX devices 320a may include sensors, actuators, and room controllers. Measurement needs can arise when collecting data from these devices to analyze energy consumption, occupancy levels, temperature, and other environmental factors. By integrating BACnet devices 316a and KNX devices 320a, facility managers can create a unified system where telemetry data from different protocols is collected, analyzed, and used to optimize building operations, enhance energy efficiency, and ensure occupant comfort.

A third example measuring instrument template 366 in the exemplary implementation of FIG. 3 is applied to perform common calculations 366a on devices following three different protocols. A first protocol is for SNMP devices 318a connected to subnetwork switch 318. A second protocol handled by the third measuring instrument template 366 is for third party applications 314a communicating via APIs and connected via third party server 314b to a subnetwork switch 314. A third protocol managed by the third measuring instrument template 366 receives manual value entries from user devices 326 of authorized personnel connected via a network switch 324.

For example, in an IT infrastructure management system or IT office spaces, SNMP-enabled devices 318a such as switches, routers, and servers provide real-time performance metrics like network bandwidth, CPU utilization, and error rates. Measurement is used to analyze and monitor the network health and identify any issues. Additionally, third-party applications 314b or monitoring tools can provide data related to application performance, user activity, or security events. By combining the SNMP device data, third-party application data, and manually entered data (such as maintenance records or incident reports), comprehensive measurement and analysis can be performed to gain insights into network performance, resource utilization, and overall system health. This integration allows for a holistic view of the network environment and enables effective decision-making and troubleshooting.

In the exemplary network installation 300, each subnetwork switch 312, 314, 316, 318, 320, 322 is connected to a plurality of devices using a different communication protocol than the other peer subnetworks. However, the virtual measuring instrument templates 362, 364, 366 provide feasible and practical connections to any number of devices to normalize and process the generated data. The data can be integrated into combinatory reports for presentation to a user on the user client device 342 for visualization and analysis, enabling informed decision-making across the facility or across multiple facilities under the same proprietor or management.

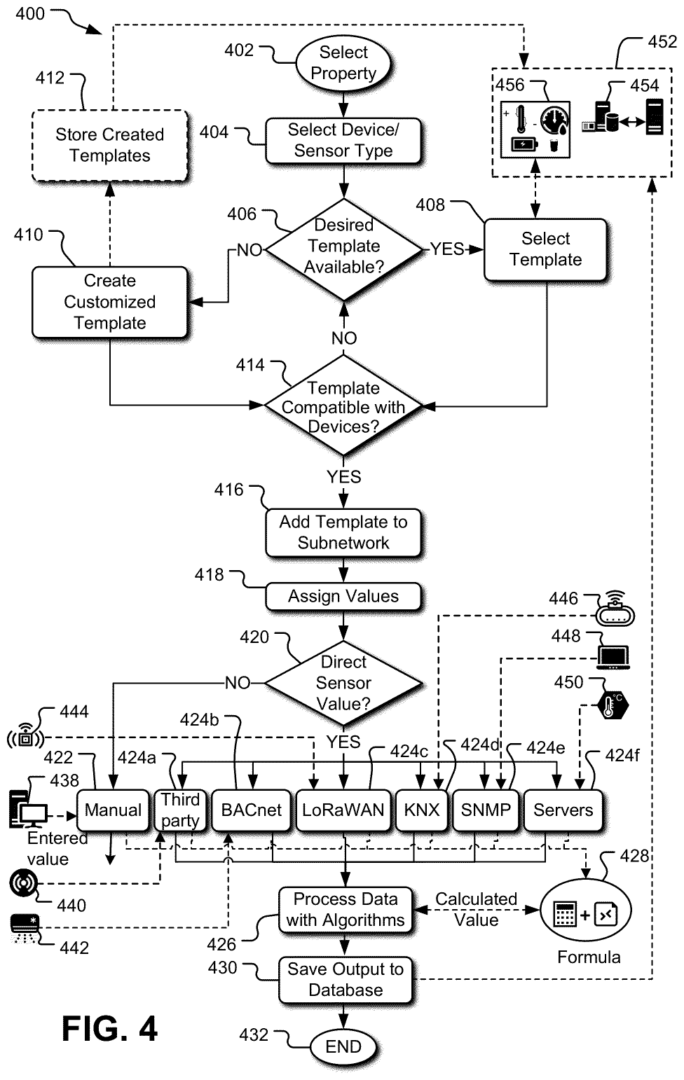

FIG. 4 is a flow diagram of an exemplary method 400 for implementing a measuring instrument system through the access control device on the premises network. The user can select and use a measuring instrument template from an inventory stored on or accessed through the access control device on a premises network to normalize, aggregate, organize, and present data generated by devices and sensors connected to the premises network. Initially, a particular premises or network installation is selected as indicated in operation 402. If the user has access to only one premises, the selection would be limited to that single property. However, if the user has management responsibility over multiple premises, a selection can be made from among a list of the co-managed properties. The selected property may represent a specific location or facility where the measuring instrument templates will be applied.

The user is next directed to select a premises asset type or device type on the selected premises for configuration as indicated in operation 404. The device type may reflect a collection of a plurality of like devices or sensors connected together on a subnetwork of the premises network. Selection of the device type can involve establishing a connection or communication link with the devices or sensors on the subnetwork to retrieve data or interact with device or sensor functionalities. By establishing communication links, the access control device can gather information or perform actions on the selected subnetwork of device or sensors.

The user may next review the options for measuring instrument templates within the template library 456 on the access control device 452 to determine whether a measuring instrument template compatible with the subnetwork communication protocol and the type of data or measurements desired for retrieval from the device or sensors is available as indicated in operation 406. A variety of pre-defined templates may be provided in the template library 456 for application to different types of data inputs. Each template may be designed to handle a particular type of data input, such as temperature, humidity, pressure, or other relevant parameters. If a template is available that meets the desired specifications, measurement requirements, or calculations, the user can select the appropriate measuring instrument template as indicated in operation 408. By selecting the measuring instrument template, the user specifies the desired computation or analysis to be performed on the telemetry data collected from the devices or sensors. The chosen measuring instrument template serves as a blueprint for processing the data collected from the devices or sensors and applying the specified algorithms to generate the desired output.

Alternatively, if the predefined measuring instrument templates in the template library 456 do not meet interface with the network protocols or do not process the desired data, or process the data in a desired way or out put the processed data in a desired format or presentation style, the user can create a custom template as indicated in operation 410. The measuring instrument system can provide a template builder interface which receives the manual input of formulas, criteria, thresholds, and other pertinent parameters that are tailored to the specific communication protocols of the subnetworks of desired devices or sensors, and measurement and calculation requirements of the user. By leveraging the flexibility of a custom template, the user can continue to fine-tune it to meet their unique needs, thereby ensuring its precise alignment with the intended computations. Once a custom template is created, it can be stored in the template library 456 for future use, e.g., on a separate premises network. Once created, the custom template becomes fully accessible for data collection and the execution of calculations on telemetry data received from selected devices within the premises network.

Upon the selection of an existing template or the completion of the custom template creation process, the process verifies the operability of the measuring device template with respect to the communication protocols of the subnetwork and the telemetry data generated by the devices or sensors thereon as indicated in operation 414. This check ensures that the template can function within the subnetwork and that the data output from devices or sensors on the subnetwork adequately supports the data ingest requirements for the specific measuring instrument template measurement and calculation inputs provided therein. If the verification operation 414 returns an error, for example, it determines that data input expected for the template is missing or there is a communication protocol mismatch, the process returns to operation 406 to allow the user to select an alternative measuring instrument template from the template library 456 or to create a new custom template. The measuring instrument system can provide feedback to the user indicating the problems with the previously selected or created template, for example, identification of missing data from the devices or sensors or communication protocol mismatches.

Upon selection of an appropriate measuring instrument template, the template is associated with one or more subnetworks of devices and sensors as indicated in operation 416. Association of the measuring instrument templates can occur within the access control device or, alternately, within a communication protocol control system connected within the subnetwork. Successful association of a template with a subnetwork is premised upon compatibility with the communication protocol of the devices or sensors on the selected subnetworks as well as the ability to ingest and process the types of telemetry data generated on the subnetworks (e.g., temperature readings vs. indications of doors opening and closing). Once a measuring instrument template is successfully associated with a specific subnetwork, it is operational and may be referred to as a virtual measuring instrument.

As noted, the measuring instrument templates can be implemented as software routines on the access control device or within a virtual machine or container thereon to interface with and receive telemetry data from the devices or sensors on the subnetwork. The access control device can thus interpret and analyze data input based on the predefined formulae and thresholds of the template. For example, consider a scenario in which a combination of information from sets of devices or sensors using one of BACnet and KNX protocols is desired. A BACnet protocol and associated controller is typically used with HVAC systems and a KNX gateway is typically used to manage lighting and power devices. In this example, the measuring instrument template can be designed to measure and analyze temperature and energy consumption from telemetry data received from the BACnet controller and KNX gateway.

In an alternate implementation, a measuring instrument template can be introduced into the firmware or software of a communication protocol control system connected to the subnetwork. For example, in the context of BACnet, the measuring instrument template can be configured as software for instantiation on the BACnet network controller or as a firmware update or plug-in. Similarly, the measuring instrument template can be configured as software for instantiation on the KNX gateway or as a firmware update or plug-in. By integrating the template into the firmware or software of the BACnet controller and KNX gateway, each become equipped to normalize data from sensors and devices adhering to their respective protocols. For example, the BACnet controller can collect temperature data from BACnet-compliant sensors, while the KNX gateway can gather energy consumption information from KNX-compatible power meters. The measuring instrument template added to the firmware or added as software enables the BACnet controller or KNX gateway device to perform calculations and analysis on the collected data, producing consistent and unified output regardless of the underlying protocols.

After the measuring instrument template has been associated with a subnetwork to monitor the devices or sensors on the subnetwork, the user can be prompted to manually assign parameter values to the newly added virtual measuring instrument as indicated in operation 418. For example, if the virtual measuring instrument is connected to devices from different protocols such as BACnet and KNX, the user can map the sensor values output from these devices, such as temperature readings, humidity levels, or occupancy status, for assignment to the corresponding virtual measuring instrument needed such data. Example parameter values can include calibration values, nominal operation parameters or thresholds, desired units (e.g., Fahrenheit or Celsius; standard or metric), or any other necessary information required for accurate measurement and calculation. By manually assigning parameter values, the virtual measuring instruments can effectively collect data from the respective devices or sensors and accurately and uniformly perform computations. For example, input of calibration values helps ensure that the virtual measuring instruments are calibrated and configured correctly, allowing for accurate and meaningful measurement results. Additionally, manual value assignment enables customization and fine-tuning of the measuring instruments to suit the specific requirements and characteristics of the devices being monitored.

Upon final instantiation and configuration of a virtual measuring instrument, it is ready to receive data from an associated subnetwork as indicated in operation 420. The virtual measuring instrument can determine based upon the type of network communication protocol whether the telemetry data received will be manually input by a user or automatically and directly received from devices or sensors on the subnetwork. In a first example depicted in FIG. 4, a client computer 438 is a source of data input for the virtual measuring instrument as indicated in manual data ingest operation 422. Data input received from manually entered values by a client computer 438 is indicated in the process flow by operation 420. The client computer 438 represents the process of manually inputting data values or parameters directly into the virtual measuring instrument that may not be obtained from automated devices or protocols. Manual data input received at operation 422 can include numerical values, text descriptions, thresholds, criteria, or any other parameters required for calculations or analysis. Use of a client computer 438 for manual data input through operation 422 is also the mechanism for mapping and assignment of values in operation 418.

Manual entry is typically done through a user interface or input form provided by the virtual measuring instrument or associated software. The user enters the data values based on their knowledge, observations, or external sources. For example, in a building management system, the user may manually enter specific setpoints or desired operating conditions for HVAC systems. They may enter target temperatures, humidity levels, or other control parameters based on their requirements or preferences. The manual entry process allows for customization and flexibility in adjusting or fine-tuning the parameters according to specific needs or circumstances. It also allows for incorporation of subjective or qualitative information that may not be available through automated output from devices or protocols. Once the data is entered into the virtual measuring instrument, it becomes part of the dataset used for calculations, analysis, or generating outputs. The virtual measuring instrument may include validation checks or error handling mechanisms to ensure the accuracy and integrity of the manually entered data.

A variety of automatic data inputs can be received by virtual measuring instruments connected to different subnetworks operating on different communication protocols. As a first example, API data ingest operation 422a represents data automatically sent from a sensor subnetwork 440 through third party API protocols. As previously described herein, the devices or sensors 440 may operate using a third-party application that first communicates the raw data to a third-party computer server through specific APIs. The APIs serve as a standardized mechanism for disparate software systems to engage and exchange data. In this context, the third-party applications would submit the data and processing requests to a third-party computer server, either within or external to the premises network. Upon receipt of the raw data and requests, the third-party server would process the raw data as per software configuration by the third-party and transmit a response to the devices or sensors with the results of the processed data. The processed data is then provided to the virtual measuring instrument in a form expected and usable by the virtual measuring instrument.

In another example, devices on a BACnet subnetwork 442 send data to a corresponding virtual measuring instrument in a BACnet data ingest operation 422b. Example electronic devices using the BACnet protocol for communication can include sensors, controllers, actuators, and other components used in building automation systems. BACnet protocol allows these devices to exchange data and coordinate their operations, enabling the automation and control of various building systems such as HVAC, lighting, access control, and more. An example of a BACnet device is a BACnet-enabled temperature sensor. This sensor would be responsible for measuring the ambient temperature in a specific area or zone of a building. The BACnet temperature sensor would continuously collect temperature data and communicate it over the BACnet subnetwork 442 to other devices, such as a BACnet controller on the subnetwork or a central building management system. The BACnet protocol ensures interoperability among different BACnet devices from various manufacturers, allowing them to communicate seamlessly and exchange data. This enables facility managers to monitor and control building systems efficiently, optimize energy usage, and create a comfortable and productive environment for occupants.

In another example, devices on a LoRaWAN subnetwork 444 send telemetry data to a corresponding virtual measuring instrument in a LoRaWAN data ingest operation 422c. Example electronic sensor devices using the LoRaWAN protocol to wirelessly transmit data over long distances with low power consumption can include smart parking system sensors that monitor parking space availability in real-time, enabling drivers to quickly find vacant spots and reducing traffic congestion; and waste management sensors for monitoring bin fill levels and optimizing collection routes. These sensors are designed for and particularly useful in scenarios where extensive coverage, low energy consumption, and long battery life are essential.

In a further example, a plurality of devices on a KNX subnetwork 446 send telemetry data to a corresponding virtual measuring instrument in a KNX data ingest operation 422d. KNX devices can encompass a variety of sensors, actuators, switches, and other control elements that contribute to the automation and control of various building systems. KNX devices are designed to inter-operate seamlessly within a KNX subnetwork 446, enabling the exchange of data and commands. In a facility management system, KNX devices communicate with each other and with a central control system using the KNX communication protocol. They NKX devices are connected via a common bus, typically a twisted pair wire or on an IP network, which allows for distributed control and monitoring. The KNX communication protocol employs a peer-to-peer communication model, meaning that devices can exchange information directly between each other without relying on a central server.

An example of a KNX device in a premises is a temperature sensor, which can be installed in different areas of a building to measure the ambient temperature. The temperature sensor collects temperature data and communicates it over the KNX subnetwork using the KNX communication protocol. The central control system or other KNX devices, such as an HVAC controller, can receive this temperature data and use it to regulate the heating, ventilation, and air conditioning systems in the building. The KNX devices operate based on a standardized set of commands and data formats defined by the KNX communication protocol. The KNX devices can send and receive data, issue control commands, and respond to requests from other devices. This standardized approach ensures interoperability between different KNX devices from various manufacturers, allowing for seamless integration and efficient management of building systems.

In another example, a plurality of devices on a SNMP subnetwork 448 send data to a corresponding virtual measuring instrument in a SNMP data ingest operation 422e. Devices on the SNMP subnetwork 448 obey SNMP protocol which is widely used in information technology (IT) and network management systems to manage and monitor network devices, gather information, and perform remote configuration. Example SNMP devices can include various network devices such as routers, switches, server computers, printers, and other locally installed sensors connected to local servers communicating with a subnetwork switch through APIs. SNMP devices have built-in SNMP agents that collect and store data about their operational status, performance, and other relevant information. The SNMP communication protocol allows administrators to remotely monitor and manage these devices by querying and receiving telemetry data from the SNMP agents.

The SNMP protocol operates based on a client-server model. An SNMP manager operates on a local server, which sends requests to the SNMP agents running on the managed devices. The SNMP manager uses SNMP-specific commands, known as Protocol Data Units (PDUs), to retrieve or modify information on the devices. SNMP devices communicate using SNMP messages, which consist of SNMP PDUs encapsulated within SNMP packets. These messages are exchanged over the network using the User Datagram Protocol (UDP). The SNMP manager sends requests, known as SNMP “Get” requests, to retrieve specific information from the SNMP agents. The SNMP agents respond with SNMP “Get Response” messages containing the requested data. SNMP devices also support SNMP traps, which are unsolicited messages sent by the SNMP agents to notify the SNMP manager about specific events or conditions, such as an interface going down or a critical system error. SNMP traps provide real-time notifications to the SNMP management system, allowing administrators to proactively respond to network issues.

In an additional example, a plurality of devices on a local server subnetwork 450 send data to a corresponding virtual measuring instrument in a SNMP data ingest operation 422f. Example devices and sensors connected together on a local server network 450 can capture various types of data, such as environmental conditions, occupancy information, energy consumption, or security events. The local servers act as intermediaries between the sensors and the access control device or virtual measuring instrument deployed within the local server system. The local servers receive telemetry data from the devices or sensors either directly or through local network gateways or interfaces. The data is then processed by the virtual measuring instrument and communicated to the access control device. Communication between the local servers and the access control device typically occurs through APIs. The access control device can also send commands or configuration updates to the local servers via APIs. For example, the access control device can send instructions to adjust temperature set-points, modify security settings, or activate/deactivate specific sensors. This communication between locally installed sensors, local servers, and the access control device enables real-time monitoring, control, and automation of various building management aspects. The access control device can aggregate data from multiple sources, perform analysis, trigger actions, and provide a comprehensive view of premises operations.

The virtual measuring instruments are designed to be flexible and versatile. The virtual measuring instruments act as a bridge between the different data sources and presentation interfaces rendered to users by the access control device. The virtual measuring instruments incorporate the logic and algorithms to receive, interpret, and process data inputs from multiple protocols. The virtual measuring instrument, per its design, can handle the data transmission protocols and formats specific to each source, extracting the relevant information and converting it into a unified format that can be processed by the measuring instrument. By supporting multiple protocols and data sources, the virtual measuring instruments enable the aggregation and synchronization of data from diverse devices and systems. This allows for comprehensive monitoring, analysis, and computation of data from different sources, providing a unified view and facilitating informed decision-making.

Data ingest operations 422, 424a-f reflect a framework for receiving data inputs from a wide range of data sources and protocols, enabling comprehensive data collection and analysis. Depending upon its configuration, a virtual measuring instrument can accommodate one or more different data sources and protocols to perform one or more of the data ingest operations 422, 434a-f. The virtual measuring instruments can be equipped with one or more algorithms, predefined to process and analyze diverse telemetry data received from one or multiple sources and protocols as indicated in operation 426. The data received through data ingest operations 422, 424a-f can be processed using one or more algorithms, formulas, or calculations 428 configured within the virtual measuring instruments. The measuring instrument templates includes variables, mathematical operations, functions, and logical expressions that are necessary for the calculations. The virtual measuring instrument maps the ingested data to the appropriate variables in the algorithm 428. This ensures that the relevant input values are correctly assigned to the corresponding parameters in the algorithm 428. Once the variables are assigned with the input data points, the algorithm 428 is executed. Intermediate calculations may be performed as part of the algorithm execution to derive intermediate values or intermediate results that contribute to the final output.

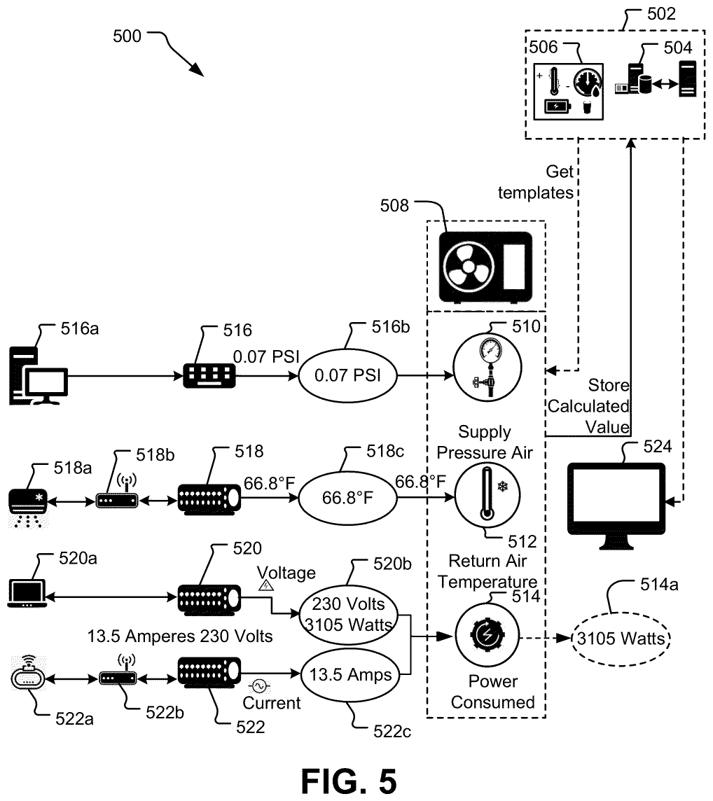

To ensure accuracy and reliability of calculation performed within algorithms 428, the measuring instrument may incorporate error handling mechanisms. These mechanisms can detect and handle exceptional cases or invalid input values, such as division by zero or out-of-range values, to prevent calculation errors and ensure the integrity of the results. Finally, the calculated results are generated as the output of the virtual measuring instrument. The output can take various forms depending on the specific application, ranging from numerical values and derived parameters to statistical measures and graphical representations. The algorithms 428 enable the aggregation, computation, and transformation of data into meaningful information, facilitating decision-making, monitoring, and control. Example calculations by algorithms 428 within a virtual measuring instrument are described further herein with respect to FIG. 5.

After the calculations within the one or more algorithms 428 are performed using the virtual measuring instrument, the resulting output is transmitted to the database 454 on the access control device 452 as indicated in operation 430 for storage or updating of values previously stored in a data structure thereon. The database 454 serves as a central repository for storing and managing the measured and processed data. This data storage operation 430 ensures the persistence and availability of the data and calculated or derived values for further analysis, reporting, and retrieval. The database 454 can be designed to handle data from various sources and protocols, including SNMP, KNX, BACnet, LoRaWAN, local APIs, third-party APIs, and manual entry. The database 545 can accommodate the different data formats and protocols by employing appropriate data normalization techniques to ensure uniformity and consistency in the stored data. The database 454 can also include features such as data indexing, query optimization, and data integrity mechanisms to enhance performance and maintain the accuracy and reliability of the stored instrument values. The database 454 can leverage relational database management systems (RDBMS) or other specialized database technologies, depending on the specific requirements of the measuring instrument system.

The system can also provide a visualization module to provide for the generation of reports or visualizations to provide insights into the measured parameters, historical data tracking, and trend analysis. The data stored in the database 454 can be accessed and presented to end users in a visualization form, typically through charts or graphs. Visualization helps effectively convey the measured data and enables users to understand and interpret the information at a glance. The system can offer a user interface or a dedicated visualization module that allows users to select the desired parameters, timeframes, and visualization options. The system retrieves the relevant data from the database 454 and transforms it into visual representations, such as line charts, bar graphs, pie charts, or scatter plots.

By visualizing the data, end users can observe trends, patterns, and anomalies in the measured parameters over time. The end user can identify correlations, compare different data sets, and make informed decisions based on the insights derived from the visual representations. The visualization module may provide interactive features, allowing users to zoom in, filter data, or switch between different visualization types dynamically. This interactivity enhances the user experience and facilitates in-depth analysis of the measured data. Furthermore, the measuring instrument system may support real-time visualization, continuously updating the charts or graphs as new data becomes available. This enables users to monitor the measured parameters in real time and respond promptly to any changes or abnormalities. Overall, the visualization of the measured data in the form of charts or graphs empowers end users to gain actionable insights, monitor performance, and optimize decision-making in facility management or other domains where the measuring instrument system is employed.

The schematic diagram of FIG. 5 presents example embodiments of calculations performed by multiple virtual measuring instruments within a virtual measuring instrument system 500. The example merely demonstrates use cases for purposes of explanation of an implementation of the disclosed system and methods of use, but it should be understood that different implementations and use cases are possible. The system 500 presents an example of multiple sensor types associated with a roof-top unit (RTU) 508. In this example, the RTU includes four different sensor types, each connected to separate subnetworks. Multiple virtual measuring instruments are implemented from templates and connected to the access control device 502. The templates are unique with respect to each other to conform to the requirements of each subnetwork of devices and sensors, each following different communication protocols. The access control device 502 includes a template library 506 of measuring instrument templates and a database 504 that acts as a repository to store all the outputs of calculations performed within the measuring instrument templates chosen for each subnetwork.

The RTU 508 in the exemplary embodiment is a type of HVAC system that is commonly used in commercial buildings, including offices, retail spaces, and warehouses. It is called a “rooftop unit” because it is typically installed on the roof of the building. The main purpose of a RTU is to provide heating, cooling, and ventilation to the interior spaces of a building. RTUs offer flexibility in terms of installation, maintenance, and capacity, making them suitable for different building sizes and configurations. A RTU is a self-contained unit that houses all the necessary components for HVAC operation, including a compressor, condenser, evaporator, fan, filters, and controls. The RTU is designed to handle the heating and cooling needs of a specific area or zone within the building. RTUs are preferred in commercial applications for several reasons. First, RTUs save valuable indoor space since they are installed on the roof, allowing for more usable space inside the building. Second, RTUs offer easy accessibility for maintenance and servicing since technicians can access the unit without disturbing the building occupants. Third, RTUs provide efficient heating and cooling performance while offering flexibility in terms of capacity and zoning. Additionally, rooftop units can be integrated into building management systems, allowing for centralized control and monitoring of HVAC operations.

The operation of a RTU is relatively straightforward. A RTU draws in outside air, which is filtered and conditioned based upon the temperature settings and requirements. In cooling mode, the compressor and condenser work together to cool the air, while in heating mode, the RTU uses a heating element or a heat pump to warm the air. The conditioned air is then distributed throughout the building by a fan via duct-work and vents.

In the example of FIG. 5, three different measuring instrument templates have been selected for configuration and instantiation as virtual measuring instruments to receive and process data from four different types of sensors associated with RTUs 508 in the premises, each communicating on different subnetworks with different communication protocols. A first virtual measuring instrument 510, a supply air pressure instrument, is selected from the template library 506 stored on the access control device 502, can be configured to process an algorithm using supply air pressure readings as input. In the context of a RTU 508, the first virtual measuring instrument 510 can receive recorded pressure levels within the RTU 508. The first virtual measuring instrument 510 is configured to receive inputs in the unit of pressure, which in this example is pounds per square inch (PSI). The supply air pressure readings are manual values of pressure data 516b entered using a client computer 516a connected to the premises network by subnetwork switch 516.

In the example of FIG. 5, pressure data 516b of 0.071 PSI has been received in the first virtual measuring instrument 510. This value represents the pressure reading obtained from a manual entry source, which could be a pressure sensor or gauge connected to the RTU. A technician performing maintenance or servicing the RTU 508 enters the supply air pressure on a corresponding interface in a user device 438, for example, a tablet computer. The first virtual measuring instrument 510 is designed to capture and process this value. By entering the manual entry data in the first virtual measuring instrument 510, the access control device 502 can effectively interpret and analyze the pressure reading. The algorithm 510a may be configured to perform various calculations or comparisons based on the predefined criteria and thresholds set within the first virtual measuring instrument 510.

The access control device 502 can receive the processed data and conduct further manipulation. For example, the premises management system operating on the access control device 502 can evaluate whether the pressure reading falls within an acceptable range or if it exceeds a certain limit. The purpose of monitoring the pressure in an RTU is to ensure that it operates within optimal conditions. Pressure is an important parameter that affects the performance and efficiency of the HVAC system within the RTU. By continuously measuring and analyzing the pressure data, the premises management system can detect any abnormal fluctuations or deviations that may indicate a potential issue or inefficiency. The first virtual measuring instrument 510 thus processes and interprets the pressure data from various sensors, including manual entries. The pressure reading data 516b, i.e., the value of 0.71 PSI, as well as the results of any calculations performed by algorithms in the first virtual measuring instrument 510, are then stored in the database 504.

A second virtual measuring instrument 512 is an instantiation of a return air temperature template accessed from the template library 506 and applied to a plurality of BACnet devices 518a connected via a BACnet gateway 518b and coupled with a subnetwork switch 518. The second virtual measuring instrument 510 is configured to perform a set of pre-defined calculations on temperature data 518c of air being drawn back into the RTU 508 from the conditioned space to provide for accurate monitoring and control of the HVAC system. In the depicted example, the temperature data 510c, presented as a reading of 66.8 degrees Fahrenheit, is sent from a BACnet sensor on one of the RTUs in the subnetwork. The second virtual measuring instrument 512 includes one or more algorithms, formulas, and criteria, to calculate, display, and potentially trigger actions based on the return air temperature data 518c. These actions can include adjusting the cooling or heating set-points, activating alarms if the temperature exceeds certain thresholds, or providing data for energy management purposes. The second virtual measuring instrument 510 considers the specific requirements and parameters of the RTU system 508, such as acceptable temperature ranges, desired comfort levels, energy efficiency goals, and safety considerations. By utilizing the second virtual measuring instrument 510, facility managers and HVAC technicians can effectively monitor and manage the return air temperature data 518c, ensuring optimal performance and comfort within the conditioned space. The output reading of 66.8 degrees Fahrenheit and any calculations performed by the algorithms on the second virtual measuring instrument 512 are stored in the database 504.

A third virtual measuring instrument 514 is an instantiation of a “power consumed” template accessed from the template library 506 and applied to a plurality of and applied to two subnetworks of respective pluralities of devices. In this example, the subnetworks and the devices thereon follow two different communication protocols. The first subnetwork is an SNMP device subnetwork 520a coupled with subnetwork switch 520. The second subnetwork is a KNX device subnetwork 522a connected via a KNX gateway 522b and coupled with subnetwork switch 522. In this example, the SNMP devices provide voltage input data 520b of 230 volts. The KNX devices provide current input data 522c of 13.5 amps. The third virtual measuring instrument 514 is designed to accommodate these diverse inputs by incorporating functions and formulas that can handle data from different protocols.

For example, the third virtual measuring instrument 514 may include conversion functions to ensure that the voltage and current inputs are in a compatible format for calculation. This could involve converting the current from amps to milliamps or ensuring consistent units for voltage measurements. Once the inputs are standardized, the algorithm can use mathematical operations such as multiplication, as in this case, to calculate the desired output 514a. By multiplying the voltage data 520b (230 volts) by the current data 522c (13.5 amps), the third virtual measuring instrument 514 can derive the power output 514a of the RTU 508, which in this example is determined to be 3105 watts. The voltage data 520b, the current data 522c, and the calculated power output data 514a are then stored in the database 504 within the access control device 502. By utilizing the third virtual measuring instrument 514, the premises management system can effectively calculate and monitor the power consumption for each RTU 508 or all RTUs within the premises. This information is valuable for energy management, assessing system efficiency, and identifying any anomalies or deviations in power consumption that may require attention or adjustments.

The virtual measuring instruments 510, 512, 514 act as a bridge between the different communication protocols and data formats, enabling the premises management system to harmonize and process these inputs. The virtual measuring instruments 510, 512, 514 abstract the complexity of handling diverse data sources by providing a unified interface for calculations. This allows facility managers and operators to easily monitor and analyze the performance of the RTU system, irrespective of the protocol-specific inputs.

When the virtual measuring instruments 510, 512, 514 perform calculations on the input data 516b, 518c, 520b, 522c received from various subnetworks using different communication protocols and any resulting output data 514a are captured and saved to the database 504. Each of the input data 516b, 518c, 520b, 522c and the output data 514a can be associated with relevant metadata, such as a timestamp of measurement, the specific measuring instrument template used, and any additional contextual information. The architecture of the database 504 can be designed to efficiently store and manage large volumes of data, ensuring data integrity and accessibility. The database can be configured for structured storage of the measured and computed values, enabling efficient querying and retrieval of data based on various parameters. By storing the input data 516b, 518c, 520b, 522c and the output data 514a in the database 504, the premises management system provides a centralized location for accessing and analyzing the measured and calculated data. This enables users, such as facility managers or building operators, to view historical trends, generate reports, and gain insights into the performance of different systems or devices over time. Additionally, the database 504 may also support functionalities such as data aggregation, data validation, and data backup to ensure the integrity and reliability of the stored information and facilitate efficient data analysis, decision-making, and system optimization.

The input data 516b, 518c, 520b, 522c and the output data 514a stored in the database 504 can be accessed through a user client computer system or device 524. Such a user device 524 is typically operated by a premises manager or facility manager or vendor and can present data through a browser interface generated by visualization software installed within the access control device 504. The visualization software provides a graphical representation of the data. The visualization software can generate various types of charts, graphs, and tables to display the data in a meaningful way for end users to understand depending on the configuration. The visualization software can also provide interactive features like filtering, sorting, and drilling down to explore the data in greater detail. For example, the end user of an RTU may access the visualization software to view the real-time telemetry data collected from different sensors and measuring instruments of RTUs in the premises. For example, the visualization software may display a line graph of the return air temperature over time, a bar chart of the power consumption of the RTU, or a table of the current status of different components of an RTU. The end user can use this information to identify any issues in the RTU system and take corrective action. In addition, the visualization software can also provide features for setting alarms and notifications to alert the end user of any abnormal or critical situations in the system. These notifications can be delivered via email, SMS, or other means, depending on the preference of the user. Overall, the visualization software can provide end users with easy-to-understand insights from the data stored in the database 504, enabling the user to make informed decisions and take actions to optimize the performance of the RTU and improve the overall efficiency of the premises.

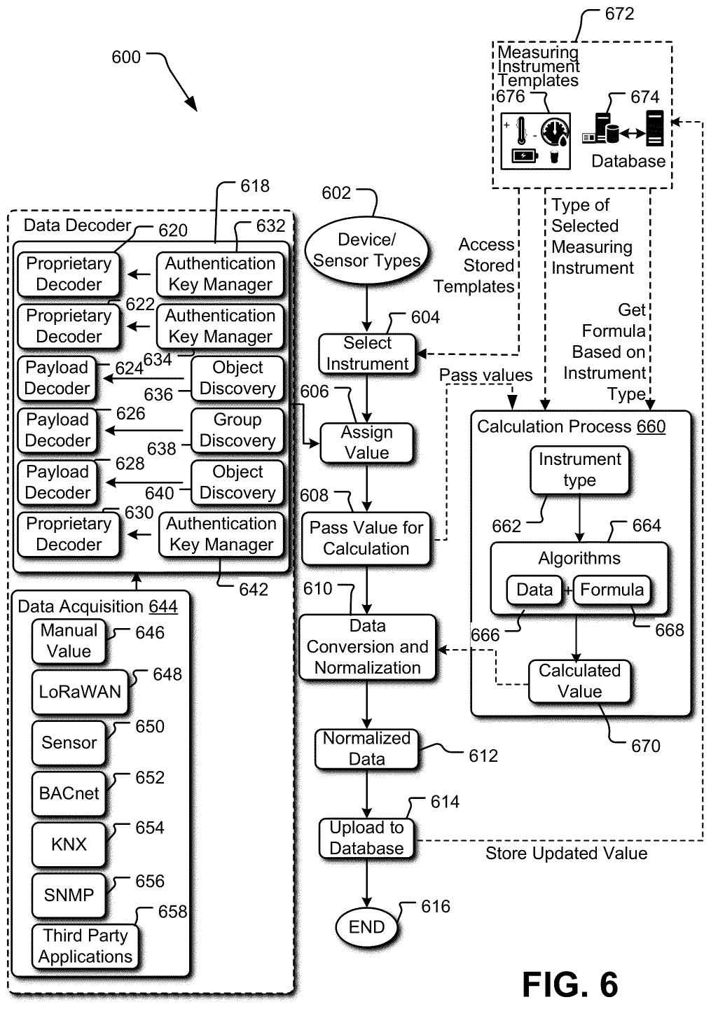

FIG. 6 is an example flow diagram 600 that represents the application of a measuring Instrument template to one or more subnetworks of like devices or sensors operating on respective communication protocols. At starting point 602, a plurality of devices, for example, a plurality of like devices or sensors on a common subnetwork or pluralities of varieties of different devices or sensors on different subnetworks are presented for selection. A measuring instrument template is chosen from the template library 676 in the access control device 672 as indicated in operation 604. The template library 676 can be part of the database 674 and acts as a repository for measuring instrument templates pertaining to different functions and calculations. The types of values or data inputs used in the computations of the selected measuring instrument template are assigned to configure the measuring instrument template as indicated in operation 606.

In complex networks and subnetworks, devices or sensors within the subnetworks can follow different communication protocols as represented in data acquisition table 644. Interfaces for different communication protocols represented in the data acquisition table 644 can include a manual value ingestion interface 646, a LoRaWAN gateway interface 648, a sensor reading interface 650, a BACNet protocol interface 652, a KNX gateway interface 654, a SNMP protocol interface 656, and various third party applications APIs 658. The data acquired from a wide range of protocols are typically entitled to their own structure, encapsulation, encoding method, protocol-specific metadata, and format and the interfaces selected for use with a particular measuring instrument template provide for receipt, identification, and translation of data so acquired.

Each of the data acquisition interfaces 644 may include a data decoder 618 with common data acquisition tools for decoding received data. In the example data decoder 618, authentication key managers 632, 634, 642 can be employed to securely manage and handle authentication keys or credentials required for establishing secure communication with devices using proprietary protocols. Authentication key managers 632, 634, 642 are commonly utilized in protocols that require secure communication, such as Hypertext Transfer Protocol Secure (HTTPS), transport Layer Security (TLS), Secure Socket Layer (SSL), or other proprietary protocols with authentication mechanisms. The proprietary decoders 620, 622, 630 work in conjunction with the authentication key managers 632, 634, 642, respectively, by receiving the encoded data from devices using proprietary protocols. The proprietary decoders 620, 622, 630 understand the unique structure and format of the proprietary protocol and apply decoding algorithms or processes to extract the underlying data. By successfully decoding the proprietary data, the proprietary decoder 620, 620, 6308 enable the authentication key managers 632, 634, 642, respectively, to access the relevant information needed for authentication purposes.

Object discovery mechanisms 636, 640 can be employed to identify and recognize objects within a communication protocol, such as sensors, actuators, or controllers. Object discovery enables the understanding of structure and hierarchy of objects, facilitating effective communication. Object discovery is often employed in protocols like BACnet, where objects represent various elements within building automation systems. Group discovery processes 638 organize objects into groups based on specific criteria, such as geographical location or functionality. Group discovery processes 638 enable efficient management and processing of data from grouped objects, enabling calculations, aggregations, and analysis based on grouped criteria. Payload decoders 624, 626, 628 can be used to assist in retrieving the payload data associated with the identified objects and groups. When objects or groups are discovered within a communication protocol, the payload decoders 624, 626, 628 extract the relevant information that defines qualities of the objects or the composition or membership of the groups. This information may include identifiers or references to the objects or devices that belong to the specific groups. The methodology of data acquisition, aggregation, and decoding resides in the access control device 672 connected to all the subnetwork of devices.

The acquired data and decoded object and group formats are passed to the measuring instrument template as additional assigned values as part of operation 606 to fully instantiate a virtual measuring instrument from the template. The assigned values are then transmitted to a calculation process 660 for population of constants and parameters therein in operation 608. The calculation process 660 is defined in the measuring instrument template with respect to the type of virtual measuring instrument 662, i.e., to reflect the types of data expected for ingestion and algorithms for output of relevant information. The algorithms 664 provided in the calculation process are combinations of data types 666 expected as output of devices or sensors on the subnetwork and functions 668 that operate on the indicated data types 666 to output desired calculated values 670.

The calculated values 670 are raw and un-normalized as are the data received from the data decoder 618. The calculated values 670 are passed to operation 610 for data conversion. Data conversion can include operations such as changing data types, converting units of measurement, reformatting data structures, or adapting data to adhere to specific standards or requirements. Once converted, the received data and the calculated values 670 can be normalized as indicated in operation 612. Data normalization can include applying mathematical transformations or adjustments to the data to eliminate variations caused by different scales, units, or reference points. Data normalization can also remove biases, normalize distributions, and enable meaningful comparisons and analysis of the data. Data normalization ensures that the data is in a suitable format for statistical modeling, machine learning algorithms, or other analytical techniques. The normalized data can then be uploaded to the database 674 in the access control device 672 as indicated in operation 614. As described above, various analytical modelling and visualization applications as part of the premises management system assemble the output data for presentation in comprehensible and insightful forms on a user computer or hand-held device.

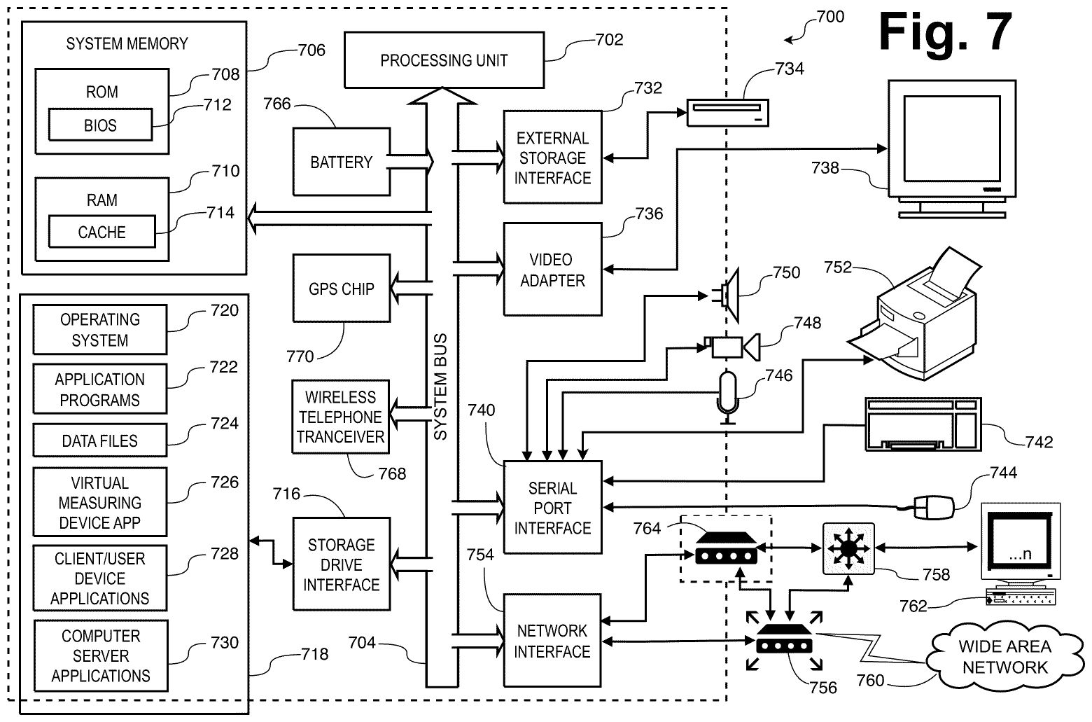

An exemplary computer system 700 embodying the access control device implementing the processes performed thereby as described above is depicted in FIG. 7. The computer system 700 embodying the access control device may be special purpose computer device, or it may be one or more of a personal computer (PC), a workstation, a notebook or portable computer, a tablet computer, a smart phone device, a video gaming device, or other computer device, with internal processing and memory components as well as interface components for connection with external input, output, storage, network, and other types of peripheral devices, particularly configured to perform the functions described herein. Internal components of the computer system 700 in FIG. 7 embodying the access control device 764 are shown within the dashed line and external components are shown outside of the dashed line. Components that may be internal or external are shown straddling the dashed line. The access control device 764 is shown encompassed by the dashed line to both indicate that the internal components are within it, and also to indicate the relationship between the access control device and the networks to which it is connected.

In any embodiment of the access control device described herein, the computer system 700 includes a processor 702 and a system memory 706 connected by a system bus 704 that also operatively couples various system components. There may be one or more processors 702, e.g., a single central processing unit (CPU), or a plurality of processing units, commonly referred to as a parallel processing environment (for example, a dual-core, quad-core, or other multi-core processing device). The system bus 704 may be any of several types of bus structures including a memory bus or memory controller, a peripheral bus, a switched-fabric, point-to-point connection, and a local bus using any of a variety of bus architectures. The system memory 706 includes read only memory (ROM) 708 and random access memory (RAM) 710. A basic input/output system (BIOS) 712, containing the basic routines that help to transfer information between elements within the computer system 700, such as during start-up, is stored in ROM 708. A cache 714 may be set aside in RAM 710 to provide a high-speed memory store for frequently accessed data.

A storage drive interface 716 may be connected with the system bus 704 to provide read and write access to a data storage drive 718, e.g., a magnetic hard disk drive or a solid-state drive for nonvolatile storage of applications, files, and data. A number of program modules and other data may be stored on the storage drive 718, including an operating system 720, one or more application programs 722, and related data files 724. If the computer system 700 is an access control device, a virtual measuring instrument application 726 implementing the communication protocol and data normalization functions described herein may be stored in the storage drive 718. Alternately, if the computer system is a remote user device, a user device application 728 can be provided thereon which cooperates and communicates with the virtual measuring instrument application 726 on the access control device. As another alternative, if the computer system 700 is a remote computer server, such as a proxy server or a database server, corresponding server computer applications 730 for coordinating, interacting, and communicating with the access control device can be stored in a corresponding data storage drive 218 thereon. Note that the storage drive 718 may be either an internal component or an external component of the computer system 700 as indicated by the storage drive 718 straddling the dashed line in FIG. 7.

In some configurations, there may be both an internal and an external storage drive. For example, one or more external storage drives 734 may be connected with the system bus 704 via an external storage interface 732 to provide read and write access to the external storage drive 734 initiated by other components or applications within the computer system 700. (In some embodiments, external storage drives may also be connected to the system bus 704 via a serial port interface 740 further described below. Exemplary external storage drives 734 may include a magnetic disk drive for reading from or writing to a removable magnetic disk 732, tape, or other magnetic media, and/or an optical disk drive for reading from or writing to a removable optical disk 738 such as a CD-ROM, a DVD, or other optical media. The external storage drive 734 and any associated removable computer-readable media may be used to provide nonvolatile storage of computer-readable instructions, data structures, program modules, and other data for the computer system 700.

The computer system 700 may include a display device 738, e.g., a monitor, a television, or a projector, or other type of presentation device connected to the system bus 704 via an interface, such as a video adapter 736 or a video card. The computer system 700 may also include other peripheral input and output devices, which are often connected to the processor 702 and memory 706 through the serial port interface 740 that is coupled to the system bus 704. Input and output devices may also or alternately be connected to the system bus 704 by other interfaces, for example, a universal serial bus (USB), an IEEE 1394 interface (“Firewire”), a parallel port, or a game port. A user may enter commands and information into the computer system 700 through various input devices including, for example, a keyboard 742 and pointing device 744, for example, a computer mouse. Other input devices (not shown) may include, for example, a microphone 746, a digital video camera 748, a digital camera, a joystick, a game pad, a tablet, a touch screen device, a satellite dish, a scanner, or a facsimile machine.

Output devices may include one or more loudspeakers 750 for presenting the audio performance of the sender. Audio devices, for example, external speakers 750 or a microphone 746, may alternatively be connected to the system bus 704 through an audio card or other audio interface (not shown). Other output devices may include, for example, a printer 752, a plotter, a photocopier, a photo printer, a facsimile machine, and a press. In some implementations, several of these input and output devices may be combined into single devices, for example, a printer/scanner/fax/photocopier. It should also be appreciated that other types of computer-readable media and associated drives for storing data, for example, magnetic disks or flash memory drives, may be accessed by the computer system 700 via the serial port interface 744 (e.g., USB) or similar port interface.

As previously described herein, the computer system 700 embodying the access control device 764 may include a battery 766 for provision of backup power in a case of general or local power outage or emergency. The access control device 764 may further include a wireless telephone transceiver 768 for provision of external communication for premises operator communication or remote vendor access in a case of local network outage or emergency. The access control device 764 may additionally include a GPS chip 770 to provide location information about the device, e.g., for security purposes as described herein. Location information identified by the GPS chip 770 may be used to enact security features for the access control device 764 as previously described herein.

The computer system 700 may operate in a networked environment using logical connections through a network interface 754 coupled with the system bus 704 to communicate with one or more remote devices. The logical connections depicted in FIG. 7 include a local-area network (LAN) 758 and a wide-area network (WAN) 760. Such networking environments are commonplace in-home networks, office networks, enterprise-wide computer networks, and intranets. These logical connections may be achieved by a network access device 756 coupled to or integral with the computer system 700. As depicted in FIG. 7, the network access device 756 is operating as both a router for directing traffic on the LAN 758 may use a router 756 or hub, either wired or wireless, internal or external, to connect with remote devices, e.g., a remote computer 758, similarly connected on the LAN 758. The remote computer 758 may be another personal computer, a server, a client, a peer device, or other common network node, and typically includes many or all of the elements described above relative to the computer system 700.

To connect with a WAN 760, the computer system 700 the network access device typically includes a modem for establishing communications over the WAN 760. However, in some embodiments, the modem for external network connections and the router for local network connections may be separate components. Most often the WAN 760 may be the Internet. However, in some instances the WAN 760 may be a large private network spread among multiple locations, or a virtual private network (VPN). The modem component of the network access device may be a telephone modem, a high-speed modem (e.g., a digital subscriber line (DSL) modem), a cable modem, or similar type of communications device. The network access device 756 with modem is connected to the system bus 704 via the network interface 754. In alternate embodiments the network access device 756 may be connected via the serial port interface 744. It should be appreciated that the network connections shown are exemplary and other means of and communications devices for establishing a network communications link between the computer system and other devices or networks may be used.

The technology described herein may be implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

The technology described herein may be implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM, DVD, or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, or any combination thereof, then the coaxial cable, fiber optic cable, twisted pair, DSL, or wireless technologies such as infrared, radio, and/or microwave are included in the definition of medium. Disk and disc, as used herein, include any combination of compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with this disclosure may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, and/or state machine. A processor may also be implemented as a combination of computing devices, for example, a combination of a DSP and a microprocessor, multiple microprocessors, one or more microprocessors in conjunction with a DSP core, and/or any combination thereof.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Furthermore, while various embodiments have been described and/or illustrated here in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may permit and/or instruct a computing system to perform one or more of the exemplary embodiments disclosed here.

In an example implementation, a method is provided within a computer system connected within a local network for aggregating diverse telemetry data received from one or more devices or sensors located within a premises and connected to the local network, the method comprising instantiating a virtual measuring instrument within the computer system, the virtual measuring instrument including one or more communication protocol interfaces and one or more predefined data acquisition tools provisioned for interaction with telemetry data generated by the one or more devices or sensors; associating the virtual measuring instrument with a first subnetwork of the local network to which the one or more devices or sensors are collectively connected, wherein the first subnetwork operates using a first communication protocol that is different from a second communication protocol used on the local network; and the one or more communication protocol interfaces of the virtual measuring instrument include a first communication protocol interface that decodes data according to the first communication protocol; receiving the telemetry data within the virtual measuring instrument from the one or more devices or sensors on the first subnetwork using the first communication protocol interface as received telemetry data; translating, using the one or more predefined data acquisition tools within the virtual measuring instrument, a format of the received telemetry data conforming to the first communication protocol to a normalized format resulting in normalized telemetry data; and configuring a presentation of the normalized telemetry data for output to a user device connected to the local network.

In another example implementation, the method further comprises applying an algorithm within the virtual measuring instrument to the received operational data to generate a calculated value derived from the received operational data.

In another example implementation of the method, a subset of the one or more devices are collectively connected to a second subnetwork of the local network that operates using a third communication protocol that is different from the first communication protocol and the second communication protocol; and the one or more communication protocol interfaces of the virtual measuring instrument include a second communication protocol interface that decodes data according to the third communication protocol; and the method further comprises receiving the telemetry data within the virtual measuring instrument from the one or more devices or sensors on the second subnetwork using the second communication protocol interface as the received telemetry data; and translating, using the one or more predefined data acquisition tools within the virtual measuring instrument, a format of the received telemetry data conforming to the third communication protocol to the normalized format resulting in the normalized telemetry data.

In another example implementation, the method further comprises receiving a template as a basis of the virtual measuring instrument from a template library connected within the local network; and receiving parameter values to populate the template before instantiating as the virtual measuring instrument.

In another example implementation, the method further comprises receiving a template as a basis of the virtual measuring instrument from a template library connected within the local network; and receiving instructions from the user device for customization of the template before instantiating as the virtual measuring instrument.

In another example implementation, the method further comprises transmitting the normalized telemetry data to a database connected to the local network for storage and collective data analysis.

In another example implementation, the method further comprises transmitting the normalized telemetry data to the user device connected to the local network in real time.

In another example implementation of the method, the computer system is an access control device connected within the local network that limits access to the devices or sensors on the local network from third-party computer systems outside the local network for security of the local network; and the user device is one of the third-party computer systems connected to the local network through the access control device.

In another example implementation of the method, the computer system is a control system connected to the first subnetwork that coordinates operations of the one or more devices or sensors connected to the first subnetwork.

In another example implementation of the method, the computer system is a gateway device that routes data traffic between the one or more devices or sensors on the first subnetwork.

In an example implementation, a system is provided for aggregating diverse telemetry data within a premises. The system includes a premises communication network further including one or more subnetworks; one or more devices or sensors connected to one of the one or more subnetworks; a computing device including one or more hardware processors; and a memory storage device configured with instructions for directing the one or more hardware computing processors to execute application programs and related programing units including a virtual measuring instrument application, when executed by the hardware processors, causes the hardware processors to instantiate a virtual measuring instrument within the computing device, the virtual measuring instrument including one or more communication protocol interfaces and one or more predefined data acquisition tools provisioned for interaction with telemetry data generated by the one or more devices or sensors; associate the virtual measuring instrument with a first subnetwork of the premises communication network to which the one or more devices or sensors are collectively connected, wherein the first subnetwork operates using a first communication protocol that is different from a second communication protocol used on the premises communication network; and the one or more communication protocol interfaces include a first communication protocol interface that decodes data according to the first communication protocol; receive the telemetry data within the virtual measuring instrument from the one or more devices or sensors on the first subnetwork using the first communication protocol interface as received telemetry data; translate, using the one or more predefined data acquisition tools, a format of the received telemetry data conforming to the first communication protocol to a normalized format resulting in normalized telemetry data; and configure a presentation of the normalized telemetry data for output to a user device connected to the local network.

In another example implementation of the system, the computing device is an access control device connected within the premises communication network that limits access to the devices or sensors on the premises communication network from third-party computer systems outside the premises communication network for security of the premises communication network; and the user device is one of the third-party computer systems connected to the local network through the access control device.

In another example implementation of the system, the computing device is a control system connected to the first subnetwork that coordinates operations of the one or more devices or sensors connected to the first subnetwork.

In another example implementation of the system, the computing device is a gateway device that routes data traffic between the one or more devices or sensors on the first subnetwork.

In another example implementation of the system, the virtual measuring instrument application, when executed by the hardware processors, causes the hardware processors to further apply an algorithm to the received operational data to generate a calculated value derived from the received operational data.

In another example implementation of the system, a subset of the one or more devices are collectively connected to a second subnetwork of the local network that operates using a third communication protocol that is different from the first communication protocol and the second communication protocol; and the one or more communication protocol interfaces of the virtual measuring instrument include a second communication protocol interface that decodes data according to the third communication protocol; and the virtual measuring instrument application, when executed by the hardware processors, causes the hardware processors to further receive the telemetry data from the one or more devices or sensors on the second subnetwork using the second communication protocol interface as the received telemetry data; and translate, using the one or more predefined data acquisition tools, a format of the received telemetry data conforming to the third communication protocol to the normalized format resulting in the normalized telemetry data.

In another example implementation of the system, the virtual measuring instrument application, when executed by the hardware processors, causes the hardware processors to further receive a template as a basis of the virtual measuring instrument from a template library connected within the local network; and receive parameter values to populate the template before instantiating as the virtual measuring instrument.

In another example implementation of the system, the one or more communication protocol interfaces each include a data decoder corresponding to a respective one of the one or more predefined data acquisition tools; and when the data decoder is executed by the hardware processors, the data decoder causes the hardware processors to further perform one or more of the following actions with respect to receiving a transmission of the telemetry data: authenticate the computing device to receive the transmission of the telemetry data; decode a proprietary encoding of the telemetry data; decode a payload of the received transmission of the telemetry data; discover objects within the transmission of the telemetry data; or discover groups of data within the transmission of the telemetry data.

In another example implementation of the system, the virtual measuring instrument application, when executed by the hardware processors, causes the hardware processors to further receive a template as a basis of the virtual measuring instrument from a template library connected within the local network; and receive instructions from the user device for customization of the template before instantiating as the virtual measuring instrument.

In another example implementation of the system, a database is connected to the premises communication network; and the virtual measuring instrument application, when executed by the hardware processors, causes the hardware processors to further transmit the normalized telemetry data to the database for storage and collective data analysis.

The process parameters, actions, and steps described and/or illustrated in this disclosure are given by way of example only and can be varied as desired. For example, while the steps illustrated and/or described may be shown or discussed in a particular order, these steps do not necessarily need to be performed in the order illustrated or discussed. The various exemplary methods described and/or illustrated here may also omit one or more of the steps described or illustrated here or include additional steps in addition to those disclosed. Similarly, the detailed description may include specific details for the purpose of providing an understanding of the described systems, structures, or apparatus. However, it may be that such systems, structures, or apparatus can be implemented without such specific details. For example, in some instances, well-known structures and apparatuses are shown in block diagram form to provide focus to new aspects in the described examples.

In addition, any disclosure of components contained within other components or separate from other components should be considered exemplary because multiple other architectures may potentially be implemented to achieve the same functionality, including incorporating all, most, and/or some elements as part of one or more unitary structures and/or separate structures.

The detailed description set forth above in connection with the appended drawings describes examples and does not represent the only instances that may be implemented or that are within the scope of the claims. The terms “example” and “exemplary,” when used in this description, mean “serving as an example, instance, or illustration,” and not “preferred” or “advantageous over other examples.”

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC, or A and B and C.

The above specification, examples and data provide a complete description of the structure and use of exemplary embodiments of the invention as defined in the claims. Although various embodiments of the claimed invention have been described above with a certain degree of particularity, or with reference to one or more individual embodiments, other embodiments using different combinations of elements and structures disclosed herein are contemplated, as other iterations can be determined through ordinary skill based upon the teachings of the present disclosure. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A method within a computer system connected within a local network for aggregating diverse telemetry data received from one or more devices or sensors located within a premises and connected to the local network, the method comprising
instantiating a virtual measuring instrument within the computer system, the virtual measuring instrument including one or more communication protocol interfaces and one or more predefined data acquisition tools provisioned for interaction with telemetry data generated by the one or more devices or sensors;
associating the virtual measuring instrument with a first subnetwork of the local network to which the one or more devices or sensors are collectively connected, wherein
the first subnetwork operates using a first communication protocol that is different from a second communication protocol used on the local network; and
the one or more communication protocol interfaces of the virtual measuring instrument include a first communication protocol interface that decodes data according to the first communication protocol;
receiving the telemetry data within the virtual measuring instrument from the one or more devices or sensors on the first subnetwork using the first communication protocol interface as received telemetry data;
translating, using the one or more predefined data acquisition tools within the virtual measuring instrument, a format of the received telemetry data conforming to the first communication protocol to a normalized format resulting in normalized telemetry data; and
configuring a presentation of the normalized telemetry data for output to a user device connected to the local network.

2. The method of claim 1 further comprising applying an algorithm within the virtual measuring instrument to the received operational data to generate a calculated value derived from the received operational data.

3. The method of claim 1, wherein
a subset of the one or more devices are collectively connected to a second subnetwork of the local network that operates using a third communication protocol that is different from the first communication protocol and the second communication protocol; and
the one or more communication protocol interfaces of the virtual measuring instrument include a second communication protocol interface that decodes data according to the third communication protocol; and
the method further comprises
receiving the telemetry data within the virtual measuring instrument from the one or more devices or sensors on the second subnetwork using the second communication protocol interface as the received telemetry data; and
translating, using the one or more predefined data acquisition tools within the virtual measuring instrument, a format of the received telemetry data conforming to the third communication protocol to the normalized format resulting in the normalized telemetry data.

4. The method of claim 1 further comprising
receiving a template as a basis of the virtual measuring instrument from a template library connected within the local network; and
receiving parameter values to populate the template before instantiating as the virtual measuring instrument.

5. The method of claim 1 further comprising
receiving a template as a basis of the virtual measuring instrument from a template library connected within the local network; and
receiving instructions from the user device for customization of the template before instantiating as the virtual measuring instrument.

6. The method of claim 1 further comprising transmitting the normalized telemetry data to a database connected to the local network for storage and collective data analysis.

7. The method of claim 1 further comprising transmitting the normalized telemetry data to the user device connected to the local network in real time.

8. The method of claim 1, wherein
the computer system is an access control device connected within the local network that limits access to the devices or sensors on the local network from third-party computer systems outside the local network for security of the local network; and
the user device is one of the third-party computer systems connected to the local network through the access control device.

9. The method of claim 1, wherein the computer system is a control system connected to the first subnetwork that coordinates operations of the one or more devices or sensors connected to the first subnetwork.

10. The method of claim 1, wherein the computer system is a gateway device that routes data traffic between the one or more devices or sensors on the first subnetwork.

11. A system for aggregating diverse telemetry data within a premises communication network, the system comprising
the premises communication network including one or more subnetworks;
one or more devices or sensors connected to one of the one or more subnetworks;
a computing device including
one or more hardware processors; and
a memory storage device configured with instructions for directing the one or more hardware computing processors to execute application programs and related programing units including a virtual measuring instrument application, when executed by the hardware processors, causes the hardware processors to
instantiate a virtual measuring instrument within the computing device, the virtual measuring instrument including one or more communication protocol interfaces and one or more predefined data acquisition tools provisioned for interaction with telemetry data generated by the one or more devices or sensors;
associate the virtual measuring instrument with a first subnetwork of the premises communication network to which the one or more devices or sensors are collectively connected, wherein
the first subnetwork operates using a first communication protocol that is different from a second communication protocol used on the premises communication network; and
the one or more communication protocol interfaces include a first communication protocol interface that decodes data according to the first communication protocol;
receive the telemetry data within the virtual measuring instrument from the one or more devices or sensors on the first subnetwork using the first communication protocol interface as received telemetry data;
translate, using the one or more predefined data acquisition tools, a format of the received telemetry data conforming to the first communication protocol to a normalized format resulting in normalized telemetry data; and
configure a presentation of the normalized telemetry data for output to a user device connected to the local network.

12. The system of claim 1, wherein
the computing device is an access control device connected within the premises communication network that limits access to the devices or sensors on the premises communication network from third-party computer systems outside the premises communication network for security of the premises communication network; and
the user device is one of the third-party computer systems connected to the local network through the access control device.

13. The system of claim 1, wherein the computing device is a control system connected to the first subnetwork that coordinates operations of the one or more devices or sensors connected to the first subnetwork.

14. The system of claim 1, wherein the computing device is a gateway device that routes data traffic between the one or more devices or sensors on the first subnetwork.

15. The system of claim 1, wherein the virtual measuring instrument application, when executed by the hardware processors, causes the hardware processors to further apply an algorithm to the received operational data to generate a calculated value derived from the received operational data.

16. The system of claim 1, wherein
a subset of the one or more devices are collectively connected to a second subnetwork of the local network that operates using a third communication protocol that is different from the first communication protocol and the second communication protocol; and
the one or more communication protocol interfaces of the virtual measuring instrument include a second communication protocol interface that decodes data according to the third communication protocol; and
the virtual measuring instrument application, when executed by the hardware processors, causes the hardware processors to further
receive the telemetry data from the one or more devices or sensors on the second subnetwork using the second communication protocol interface as the received telemetry data; and
translate, using the one or more predefined data acquisition tools, a format of the received telemetry data conforming to the third communication protocol to the normalized format resulting in the normalized telemetry data.

17. The system of claim 1, wherein the virtual measuring instrument application, when executed by the hardware processors, causes the hardware processors to further
receive a template as a basis of the virtual measuring instrument from a template library connected within the local network; and
receive parameter values to populate the template before instantiating as the virtual measuring instrument.

18. The system of claim 17, wherein
the one or more communication protocol interfaces each include a data decoder corresponding to a respective one of the one or more predefined data acquisition tools; and
when the data decoder is executed by the hardware processors, the data decoder causes the hardware processors to further perform one or more of the following actions with respect to receiving a transmission of the telemetry data:
authenticate the computing device to receive the transmission of the telemetry data;
decode a proprietary encoding of the telemetry data;
decode a payload of the received transmission of the telemetry data;
discover objects within the transmission of the telemetry data; or
discover groups of data within the transmission of the telemetry data.

19. The system of claim 1, wherein the virtual measuring instrument application, when executed by the hardware processors, causes the hardware processors to further
receive a template as a basis of the virtual measuring instrument from a template library connected within the local network; and
receive instructions from the user device for customization of the template before instantiating as the virtual measuring instrument.

20. The system of claim 1 further comprising
a database connected to the premises communication network; and
wherein the virtual measuring instrument application, when executed by the hardware processors, causes the hardware processors to further transmit the normalized telemetry data to the database for storage and collective data analysis.
